(19) United States
(12) Patent Application Publication
(10) Pub. No.: US 2015/0009437 A1
(43) Pub. Date: Jan. 8, 2015

(54) LIQUID CRYSTAL LENS DEVICE AND IMAGE DISPLAY APPARATUS

(71) Applicant: KABUSHIKI KAISHA TOSHIBA, Tokyo (JP)

(72) Inventors: Ayako TAKAGI, Yokosuka-shi (JP); Shinichi Uehara, Tokyo (JP); Masako Kashiwagi, Yokohama-shi (JP); Masahiro Baba, Yokohama-shi (JP)

(21) Appl. No.: 14/321,119

(22) Filed: Jul. 1, 2014

(30) Foreign Application Priority Data
Jul. 2, 2013 (JP) 2013-139254

(51) Int. Cl. G02F 1/133

(52) U.S. Cl. CPC G02F 1/13306
USPC 349/33

(57) ABSTRACT

According to one embodiment, a liquid crystal lens device includes an optical unit, a driver, and an estimator. The optical unit includes first electrodes provided on the first surface, each first electrode extending in a first direction, a second electrode and a liquid crystal layer provided between the first and second electrodes. A long-axis direction of a liquid crystal molecule forms an alignment direction when projected onto the first surface. The estimator estimates first and second estimated positions of a user relative to the optical unit. The driver selectively applies a voltage to the liquid crystal layer. An angle between the long-axis direction and a straight line connecting the first position and a centroid of the first surface is smaller than an angle between the long-axis direction and a second straight line connecting the second position and the centroid.

### CROSS-REFERENCE TO RELATED APPLICATIONS

This application is based upon and claims the benefit of priority from Japanese Patent Application No. 2013-139254, filed on Jul. 2, 2013; the entire contents of which are incorporated herein by reference.

### FIELD

Embodiments described herein relate generally to a liquid crystal lens device and an image display apparatus.

### BACKGROUND

There is a liquid crystal lens device that changes the distribution of the refractive index according to the application of a voltage by utilizing the birefringence of a liquid crystal. There is a display device in which such a liquid crystal lens device is combined with a display.

By changing, for example, the distribution of the refractive index of the liquid crystal lens device, such an image display apparatus switches between a state in which the image displayed by the display is caused to be incident on the eyes of a viewer as displayed by the display and a state in which the image displayed by the display is caused to be incident on the eyes of the viewer as multiple parallax images. Thereby, a two-dimensional image display operation and a three-dimensional image display operation are performed, where the three-dimensional image display operation includes stereoscopic viewing with the naked eyes. An image display apparatus having higher display quality are desirable. A liquid crystal lens device having good optical characteristics is desirable to realize high display quality.

### BRIEF DESCRIPTION OF THE DRAWINGS

FIG. 1 is a schematic view showing an image display apparatus according to a first embodiment;

FIG. 2 is a schematic plan view showing the liquid crystal lens device according to the first embodiment;

FIG. 3 is a schematic plan view showing the liquid crystal lens device according to the first embodiment;

FIG. 4 is a schematic cross-sectional view showing the image display apparatus according to the first embodiment;

FIG. 5 is a schematic cross-sectional view showing the liquid crystal lens device and the image display device according to the first embodiment;

FIG. 6 is a schematic cross-sectional view showing the liquid crystal lens device according to the first embodiment;

FIG. 7 is a schematic perspective view showing operations of the liquid crystal lens device according to the first embodiment;

FIG. 8A to FIG. 8C are graphs showing characteristics of the liquid crystal lens devices;

FIG. 9 is a schematic cross-sectional view showing another image display apparatus according to the first embodiment;

FIG. 10 is a graph showing another liquid crystal lens device according to the first embodiment;

FIG. 11A to FIG. 11C are schematic cross-sectional views showing operations of another liquid crystal lens device according to the first embodiment;

FIG. 12 is a schematic view showing an image display device according to a second embodiment;

FIG. 13 is a schematic plan view showing the liquid crystal lens device according to the second embodiment;

FIG. 14 is a schematic perspective view showing the liquid crystal lens device according to the second embodiment;

FIG. 15 is a schematic cross-sectional view showing the liquid crystal lens device according to the second embodiment;

FIG. 16A and FIG. 16B are graphs showing another liquid crystal lens device according to the second embodiment;

FIG. 17 is a schematic plan view showing a liquid crystal lens device according to a third embodiment; and

FIG. 18 is a schematic plan view showing an image display apparatus according to a fourth embodiment.

### DETAILED DESCRIPTION

According to one embodiment, a liquid crystal lens device includes an optical unit, a driver, and an estimator. The optical unit includes a first substrate having a first surface, first electrodes provided on the first surface, each first electrode extending in a first direction, a second substrate having a second surface opposing the first surface, and a second electrode provided on the second surface, and a liquid crystal layer provided between the first electrodes and the second electrode and including a liquid crystal molecule. A long-axis direction of the liquid crystal molecule is tilted at a pretilt angle to the first surface in a state without voltage application to the liquid crystal layer. The long-axis direction forms an alignment direction when projected onto the first surface. The estimator estimates an estimated position of a user relative to the optical unit. The driver is electrically connected to the first electrodes and the second electrode. The driver performs a first operation to selectively apply a first voltage to the liquid crystal layer in a first mode and a second voltage to the liquid crystal layer in a second mode according to the estimated position. The estimated position in the first mode is a first position, and the estimated position in the second mode is a second position. A position of the second position in the alignment direction is different from a position of the first position in the alignment direction. An angle between the long-axis direction and a first straight line connecting the first position and a centroid of the first surface is smaller than an angle between the long-axis direction and a second straight line connecting the second position and the centroid. A first angle between the first surface and the long-axis direction in the first mode is smaller than a second angle between the first surface and the long-axis direction in the second mode.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### First Embodiment

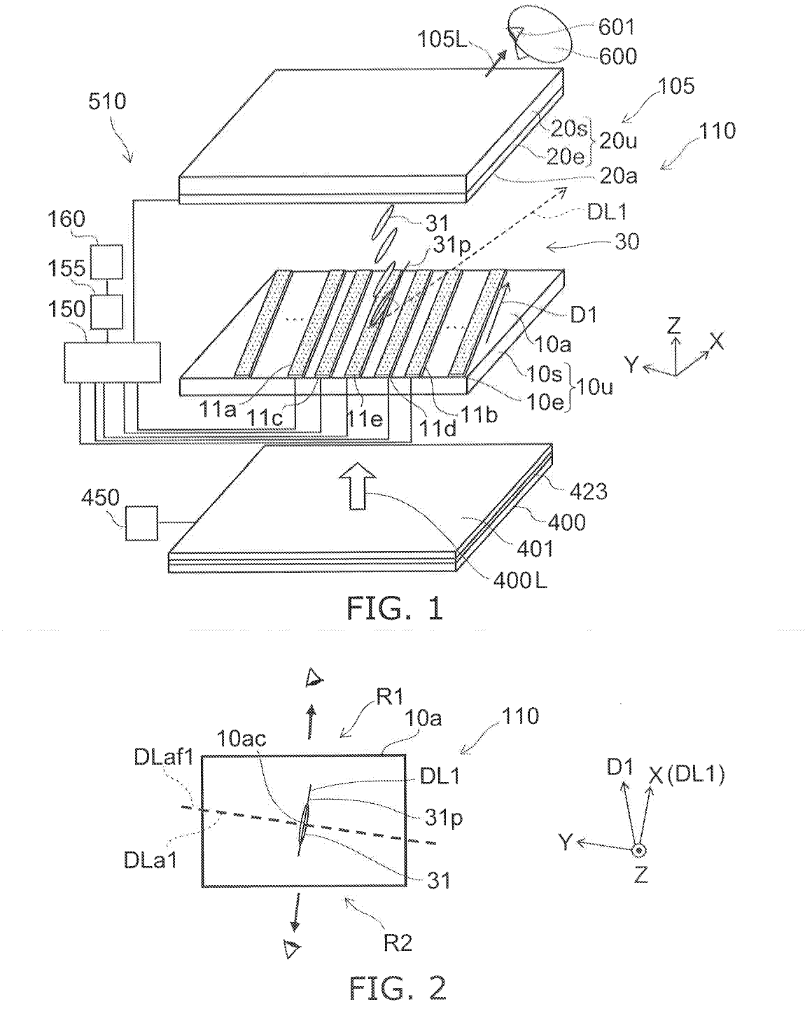

FIG. 1 is a schematic view illustrating an image display apparatus according to a first embodiment.

As shown in FIG. 1, the image display apparatus 510 according to the embodiment includes the liquid crystal lens device 110 and a display 400.

The liquid crystal lens device 110 includes an lens unit 105, a driver (a first driver 150), and a position estimation unit 160. The first driver 150 is a driver for the lens unit 105. In the example, an image driver (a second driver 450) for the display 400 also is provided.

The optical unit 105 includes a first substrate unit 10u, a second substrate unit 20u, and a liquid crystal layer 30. The liquid crystal layer 30 is provided between the first substrate unit 10u and the second substrate unit 20u.

In the image display apparatus 510, the first substrate unit 10u is disposed between the display 400 and the second substrate unit 20u.

The first substrate unit 10u includes a first substrate 10s and a first electrode 10e. The first substrate 10s is light-transmissive. The first substrate 10s has a first surface 10a. The first surface 10a is a major surface of the first substrate 10s.

A direction perpendicular to the first surface 10a is taken as a Z-axis direction. One direction perpendicular to the Z-axis direction is taken as an X-axis direction. A direction perpendicular to the Z-axis direction and the X-axis direction is taken as a Y-axis direction.

The first surface 10a is parallel to the X-Y plane. The configuration of the first surface 10a is, for example, a rectangle. In the configuration of the first surface 10a, the corners may be tilted with respect to the sides; or the corners may have curved configurations.

The first electrode 10e is provided on the first surface 10a. The first electrode 10e includes multiple conductive portions 11. For example, the first electrode 10e includes first to fourth conductive portions 11a to 11d. The first conductive portion 11a extends in a first direction D1 on the first surface 10a. The second conductive portion 11b is separated from the first conductive portion 11a in a direction intersecting the first direction D1. The second conductive portion 11b also extends in the first direction. The third conductive portion 11c is provided between the first conductive portion 11a and the second conductive portion 11b to extend in the first direction D1. The fourth conductive portion 11d is provided between the third conductive portion 11c and the second conductive portion 11b to extend in the first direction D1.

Thus, the first electrode 10e includes the multiple conductive portions 11 extending in the first direction. The number of the multiple conductive portions 11 is four or more. In the example, the first to fourth conductive portions 11a to 11d are used as one set. Such a set may be multiply provided. The multiple sets are arranged in a direction intersecting the first direction D1. At least four of the multiple conductive portions 11 are used as one set.

A fifth conductive portion 11e is further provided in the example. The fifth conductive portion 11e is disposed between the third conductive portion 11c and the fourth conductive portion 11d to extend in the first direction D1. In the example, the first to fifth conductive portions 11a to 11e are used as one set. The number of conductive portions provided in one set is arbitrary. A portion of the conductive portions may be shared with an adjacent set. For example, the second conductive portion 11b of a first set may be the same as the first conductive portion 11a of a second set.

At least a portion of each of the multiple conductive portions 11 is, for example, light-transmissive. Each of the conductive portions 11 has a band configuration extending in the first direction D1.

The second substrate unit 20u includes a second substrate 20s and a second electrode 20e. The second substrate 20s is light-transmissive. The second substrate 20s has a second surface 20a. The second surface 20a opposes the first surface 10a.

In the specification of the application, the state of being opposed includes the state of directly facing each other and the state of facing each other with another component inserted therebetween.

The second surface 20a is substantially parallel to the first surface 10a. The second electrode 20e is provided on the second surface 20a. The second electrode 20e is provided between the first substrate unit 10u and the second substrate 20s. At least a portion of the second electrode 20e is, for example, light-transmissive.

In the example, the second electrode 20e has a layered configuration. The second electrode 20e may have multiple conductive portions having band configurations.

The liquid crystal layer 30 is provided between the first substrate unit 10u and the second substrate unit 20u. The liquid crystal layer 30 includes liquid crystal molecules 31. The liquid crystal layer 30 includes, for example, a nematic liquid crystal. The liquid crystal layer 30 may include a chiral agent. The liquid crystal molecules 31 have a long-axis direction 31p.

The liquid crystal layer 30 has a pretilt. In the pretilt, the long-axis direction 31p on the first substrate unit 10u is tilted with respect to the first surface 10a.

For example, in the case where the dielectric anisotropy of the liquid crystal of the liquid crystal layer 30 is positive, the liquid crystal molecules 31 tilt and the angle between the first surface 10a and the long-axis direction 31p increases when a voltage is applied between the first electrode 10e and the second electrode 20e.

In the case where the liquid crystal layer 30 substantially does not have a pretilt, for example, the long-axis direction 31p of the liquid crystal molecules 31 is parallel to the first surface 10a. In the case where the liquid crystal layer 30 substantially does not have a pretilt, multiple regions (reverse tilt domains) having mutually-different tilt directions occur because the tilt directions of the liquid crystal molecules 31 when applying the voltage are not one direction. The optical characteristics are different between the multiple regions. Also, the optical characteristics in the boundary regions between the multiple regions are not the desired characteristics. In other words, uniform optical characteristics are not obtained.

In the case where the dielectric anisotropy of the liquid crystal is negative, the angle between the first surface 10a and the long-axis direction 31p due to the application of the voltage is smaller than that of the state in which the voltage is not applied. At this time, in the case where the liquid crystal layer 30 substantially does not have a pretilt, for example, the long-axis direction 31p of the liquid crystal molecules 31 is perpendicular to the first surface 10a. At this time, multiple regions having mutually-different tilt directions occur because the tilt directions of the liquid crystal molecules 31 when applying the voltage are not one direction. In such a case as well, uniform optical characteristics are not obtained.

Therefore, a pretilt is provided in the embodiment. In the case where the pretilt is provided, the liquid crystal alignment when applying the voltage is uniform between the first electrode 10e and the second electrode 20e. However, there are cases where the alignment of the liquid crystal is nonuniform at the edge portions of the electrode due to a lateral electric field (an electric field having a component along the X-Y plane). This nonuniformity is different from the nonuniformity in the case where the pretilt is not provided.

Information relating to the direction of the pretilt and the pretilt angle (the angle between the first surface 10a and the long-axis direction 31p) is obtained by, for example, a method for evaluating the optical characteristics of the liquid crystal layer 30 by utilizing polarized light. For example, the direction of the pretilt and the pretilt angle can be sensed by evaluating the liquid crystal layer 30 by a crystal rotation method.

The direction of the long-axis direction 31p on the first substrate unit 10u projected on the first surface 10a is referred to as a first alignment direction DL1. The first alignment direction DL1 is a direction (an orientation) inside the X-Y plane. The X-axis direction is parallel to the first alignment direction DL1.

Information relating to the first alignment direction DL1 is obtained by a method for evaluating the optical characteristics of the liquid crystal layer 30 by utilizing polarized light. The first alignment direction DL1 can be sensed from the nonuniformity of the optical characteristics caused by the nonuniformity of the initial alignment control of the liquid crystal layer 30. For example, in the case where the initial alignment of the liquid crystal layer 30 is obtained by rubbing, etc., the first alignment direction DL1 can be known from the nonuniformity of the rubbing (the rubbing lines having line configurations), etc.

The dielectric anisotropy of the liquid crystal included in the liquid crystal layer 30 is, for example, positive. The state in which a voltage is not applied to the liquid crystal layer 30 (or, in the case where the liquid crystal layer 30 has a threshold voltage, the state in which a voltage that is not more than the threshold voltage is applied) is referred to as an inactive state. The state in which a voltage (a voltage greater than the threshold voltage) is applied to the liquid crystal layer 30 is referred to as an active state. The angle between the first surface 10a and the long-axis direction 31p of the liquid crystal molecules 31 in the active state is larger than the angle between the first surface 10a and the long-axis direction 31p of the liquid crystal molecules 31 in the inactive state. The initial alignment of the liquid crystal layer 30 is, for example, a horizontal alignment having a pretilt or a HAN alignment having a pretilt. The alignment of the liquid crystal layer 30 may be twisted along the Z-axis direction.

The dielectric anisotropy of the liquid crystal included in the liquid crystal layer 30 may be negative. For example, the long-axis direction 31p of the liquid crystal molecules 31 of the liquid crystal layer 30 has a component parallel to the X-Y plane in the active state in which the voltage (the voltage greater than the threshold voltage) is applied to the liquid crystal layer 30. In such a case, the angle between the first surface 10a and the long-axis direction 31p of the liquid crystal molecules 31 in the active state is smaller than the angle between the first surface 10a and the long-axis direction 31p of the liquid crystal molecules 31 in the inactive state. In such a case, the initial alignment of the liquid crystal is, for example, a vertical alignment having a pretilt or a HAN alignment having a pretilt. The alignment of the liquid crystal layer 30 may be twisted along the Z-axis direction.

The first driver 150 is electrically connected to the first electrode 10e and the second electrode 20e. The first driver 150 changes the angle (the tilt angle) of the long-axis direction 31p with respect to the first surface 10a by applying a voltage to the liquid crystal layer 30. The effective refractive index of the liquid crystal layer 30 changes according to the angle of the long-axis direction 31p.

For example, in the case where the long-axis direction 31p is parallel to the first surface 10a, the effective refractive index (the refractive index for polarized light along the long-axis direction 31p) is the refractive index for extraordinary light of the liquid crystal. On the other hand, for example, in the case where the long-axis direction 31p is perpendicular to the first surface 10a, the effective refractive index is the refractive index for ordinary light of the liquid crystal. For example, in the case where the long-axis direction 31p is tilted with respect to the first surface 10a, the effective refractive index is a value between the two. The relationship between the tilt angle and the effective refractive index of the liquid crystal is represented by a relationship based on the index ellipsoid.

In the liquid crystal lens device 110, the alignment of the liquid crystal of the liquid crystal layer 30 changes according to the voltage applied between the first electrode 10e and the second electrode 20e by the first driver 150. For example, the voltages between the second electrode 20e and each of the multiple conductive portions 11 are different from each other. Thereby, a lens having a band configuration (e.g., a lens having a cylindrical configuration) along the first direction D1 (the extension direction of the multiple conductive portions 11) is formed. For example, a refractive index distribution (a change of the refractive index) is formed in a direction orthogonal to the first direction D1 by multiply providing lenses having band configurations. The refractive index distribution has, for example, a lenticular lens configuration.

The first substrate 10s and the second substrate 20s may include, for example, transparent glass, a transparent resin, etc.

The first electrode 10e and the second electrode 20e include, for example, an oxide including at least one element selected from the group consisting of In, Sn, Zn, and Ti. The first electrode 10e and the second electrode 20e include, for example, ITO (Indium Tin Oxide), etc. The first electrode 10e and the second electrode 20e may include, for example, a thin metal layer that is light-transmissive.

In the image display apparatus 510, such a liquid crystal lens device 110 is stacked with the display 400. In other words, the display 400 is stacked with the liquid crystal lens device 110. For example, the display 400 has a display surface 401. The liquid crystal lens device 110 is stacked with the display surface 401 of the display 400.

In the specification of the application, the state of being stacked includes the state of directly overlapping and the state of overlapping with another component inserted therebetween.

The display surface 401 is substantially parallel to the X-Y plane. Light (image light 400L) that is emitted from the display 400 is incident on the liquid crystal lens device 110. For example, the image light 400L is substantially linearly polarized light.

The display 400 includes, for example, a display layer 423. The configuration of the display layer 423 is arbitrary. The display layer 423 may include any liquid crystal display layer having, for example, a VA mode, a TN mode, an IPS mode, etc.

In the example, the operation of the display layer 423 is controlled by the second driver 450 for the display 400. The second driver 450 may be integrated with the first driver 150. The second driver 450 is connected to a display layer 423 that forms light including image information. For example, an image signal is input to the second driver 450 by a recording medium, an external input, etc. The second driver 450 controls the operation of the display 400 based on the image signal that is input. Multiple pixels (not shown) are provided in the display layer 423. The intensity of the light emitted from the multiple pixels is modulated to form an image by controlling the alignment of the liquid crystal of the multiple pixels. The image light 400L includes, for example, an image for the left eye and an image for the right eye. The light (the image light 400L) that includes the image is incident on the liquid crystal lens device 110.

In the liquid crystal lens device 110 as described above, a lens having a band configuration (e.g., a lens having a cylindrical configuration) is formed; and, for example, a refractive index distribution having a lenticular lens configuration is formed. The light (the image light 400L) including the image emitted from the display 400 is incident on the liquid crystal lens device 110; and, for example, a three-dimensional image display operation of stereoscopic viewing is performed by the refractive index distribution of the liquid crystal lens device 110 recited above.

The liquid crystal lens device 110 and the image display apparatus 510 are used by a user 600. Light 105L that passes through the optical unit 105 is incident on an eye 601 of the user 600. The user 600 perceives the image by the light 105L being incident on the eye 601.

In the embodiment, the position of the eye 601 relative to the optical unit 105 is estimated by the position estimation unit 160. The position of the eye 601 relative to the optical unit 105 includes the direction of the eye 601 relative to the optical unit 105. The position of the eye 601 relative to the optical unit 105 may not include information relating to the distance between the optical unit 105 and the eye 601.

For example, the position estimation unit 160 images the eye 601 of the user 600 and estimates the position (the direction) of the eye 601 relative to the optical unit 105 based on the image that is imaged.

The position estimation unit 160 may estimate the position (the direction) of the eye 601 relative to the optical unit 105 by, for example, sensing the relationship between the optical unit 105 and gravity. For example, there are many cases where the user 600 views the optical unit 105 from above. There are many cases where the first surface 10a of the optical unit 105 is tilted with respect to gravity at this time. The position (the direction) of the eye 601 relative to the optical unit 105 can be estimated at this time by sensing the relationship between gravity and at least one selected from the first surface 10a and the first direction D1 (the extension direction of the conductive portions 11).

In the case where the display 400 is provided, the position (the direction) of the eye 601 relative to the optical unit 105 may be estimated based on a vertical direction (e.g., the vertical direction of a character) included in the information displayed by the display 400.

Thus, the position estimation unit 160 estimates the position (the direction) relative to the optical unit 105 of the eye 601 on which the light 105L that passes through the optical unit 105 is incident.

For example, a voltage setting unit 155 (a controller) may be further provided. The voltage setting unit 155 sets, for example, the potentials (the voltages) of the first electrode 10e and the second electrode 20e based on the estimation result of the position of the eye 601 estimated by the position estimation unit 160. The voltage (or the information relating to the voltage) that is set by the voltage setting unit 155 is supplied to the first driver 150. The first driver 150 supplies the voltage (the current) to the optical unit 105 based on the voltage (or the information relating to the voltage) that is set by the voltage setting unit 155.

The voltage setting unit 155 may have, for example, a function of calculating the voltage. The voltage setting unit 155 may set the voltage by, for example, reading information stored in an information storage unit. The voltage setting unit 155 may include the information storage unit. The voltage setting unit 155 may be included in the position estimation unit 160. The voltage setting unit 155 may be included in the first driver 150.

The position estimation unit 160 may include a computer. The first driver 150 may include a computer. The computer of the position estimation unit 160 may be integrated with or shared by the computer of the first driver 150.

FIG. 2 is a schematic plan view illustrating the liquid crystal lens device according to the first embodiment.

In the example as shown in FIG. 2, the absolute value of the angle between the first direction D1 (the extension direction of the multiple conductive portions 11) and the X-axis direction (i.e., the first alignment direction DL1) is not less than 0 degrees and not more than 45 degrees. It is favorable for the angle (the absolute value of the angle) between the first direction D1 and the first alignment direction DL1 to be greater than 0 degrees. In other words, it is desirable for the first direction D1 and the first alignment direction DL1 to intersect. Thereby, the nonuniformity of the alignment of the liquid crystal molecules 31 due to the lateral electric field can be suppressed. In the example, the absolute value of the angle between the first direction D1 and the first alignment direction DL1 is not less than 5 degrees and not more than 45 degrees.

A centroid 10ac of the first surface 10a is shown in FIG. 2. In the example, the first surface 10a is rectangular (a rectangle or a square); and the centroid 10ac is the centroid of the rectangle. A first short axis plane DLaf1, a first region R1, and a second region R2 that are described below also are shown in FIG. 2.

An example of the position of the eye 601 estimated by the position estimation unit 160 will now be described.

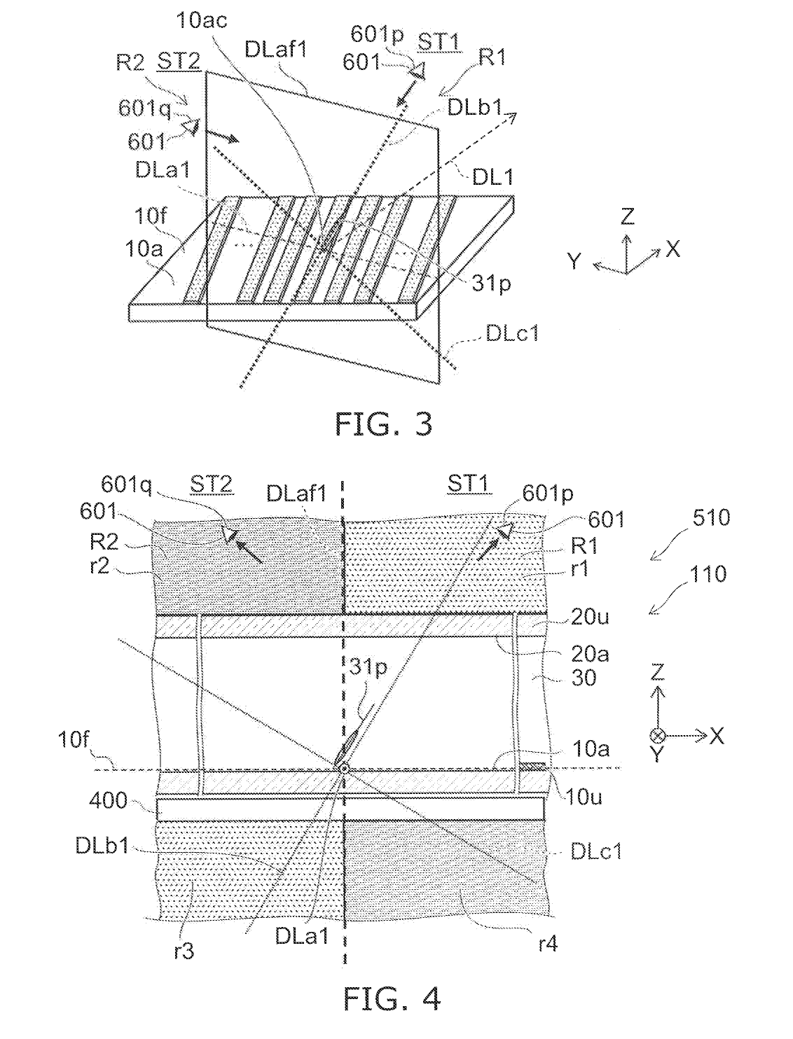

FIG. 3 is a schematic plan view illustrating the liquid crystal lens device according to the first embodiment.

FIG. 3 illustrates the alignment of the liquid crystal; and for easier viewing of the drawing, the first substrate unit 10u and the liquid crystal molecules 31 are shown; and the other components are not shown.

As shown in FIG. 3, the first short axis plane DLaf1 is set (referring to FIG. 2). The first short axis plane DLaf1 is perpendicular to the first surface 10a, is perpendicular to the first alignment direction DL1 which is the long-axis direction 31p of the liquid crystal molecules 31 on the first substrate unit 10u projected onto the first surface 10a, and passes through the centroid 10ac of the first surface 10a (referring to FIG. 2). The line segment where the first surface 10a and the first short axis plane DLaf1 intersect is referred to as a line segment DLa1. The line segment DLa1 is parallel to the Y-axis direction. On the other hand, the plane that is parallel to the first surface 10a and includes the first surface 10a is referred to as a plane 10f.

Multiple regions are partitioned by the first short axis plane DLaf1 and the plane 10f. These regions include, for example, the first region R1 and the second region R2. The second region R2 is arranged with the first region R1 along the first surface 10a.

In a first state ST1, a position (a first position 601p) of the eye 601 estimated by the position estimation unit 160 is positioned inside the first region R1. As recited above, the first region R1 is one of the regions partitioned by the first short axis plane DLaf1 and the plane 10f.

In a second state ST2, a position (a second position 601q) of the eye 601 estimated by the position estimation unit 160 is positioned inside the second region R2. As recited above, the second region R2 is another region partitioned by the first short axis plane DLaf1 and the plane 10f.

The first region R1 is the region of the multiple regions recited above on the side toward which the liquid crystal molecules 31 tilt. The second region R2 is the region of the multiple regions recited above on the side opposite to the side toward which the liquid crystal molecules 31 tilt.

A direction that passes through the line segment DLa1 (the line segment where the first surface 10a and the first short axis plane DLaf1 intersect) and is parallel to the long-axis direction 31p on the first substrate unit 10u is referred to as a long-axis central direction DLb1. The first region R1 is the region of the multiple regions recited above through which the long-axis central direction DLb1 passes.

A direction that passes through the line segment DLa1 recited above and is perpendicular to the long-axis direction 31p on the first substrate unit 10u is referred to as a short-axis central direction DLc1. The second region R2 is the region of the regions recited above through which the short-axis central direction DLc1 passes.

The second position 601q inside the second region R2 corresponds to, for example, the first position 601p inside the first region R1 when rotated around the Y-axis direction (the line segment DLa1).

The first region R1 and the second region R2 will now be described further.

FIG. 4 is a schematic cross-sectional view illustrating the image display apparatus according to the first embodiment.

FIG. 4 corresponds to a cross-sectional view in which the liquid crystal lens device and the image display device are cut by the X-Z plane of FIG. 1.

As illustrated in FIG. 4, the space is partitioned into four spatial regions (first to fourth spatial regions r1 to r4) by the first short axis plane DLaf1 recited above and the plane 10f recited above. The second spatial region r2 is arranged with the first spatial region r1 along the first surface 10a. The fourth spatial region r4 is arranged with the third spatial region r3 along the first surface 10a. The fourth spatial region r4 is arranged with the first spatial region r1 along the Z-axis direction. The third spatial region r3 is arranged with the second spatial region r2 along the Z-axis direction. The long-axis central direction DLb1 passes through the first spatial region r1 and the third spatial region r3. The short-axis central direction DLc1 passes through the second spatial region r2 and the fourth spatial region r4.

In the example shown in FIG. 4, the first spatial region r1 corresponds to the first region R1; and the second spatial region r2 corresponds to the second region R2.

In the liquid crystal lens device 110, the second substrate unit 20u is disposed between the first region R1 and the first substrate unit 10u and between the second region R2 and the first substrate unit 10u. The first position 601p of the eye 601 is disposed inside the first region R1. The second position 601q of the eye 601 is disposed inside the second region R2. In the example, the second substrate unit 20u is disposed between the first position 601p and the plane 10f (the plane that is parallel to the first surface 10a and includes the first surface 10a). The second substrate unit 20u is disposed between the second position 601q and the plane 10f.

In the embodiment, the first driver 150 modifies the voltage between the first electrode 10e and the second electrode 20e between the first state ST1 in which the position of the eye 601 estimated by the position estimation unit 160 exists inside the first region R1 and the second state ST2 in which the position of the eye 601 estimated by the position estimation unit 160 exists inside the second region R2.

The operation of the first driver 150 is described below.

The operations of the liquid crystal lens device 110 and the image display apparatus 510 will now be described as an example in which the dielectric anisotropy of the liquid crystal of the liquid crystal layer 30 is positive.

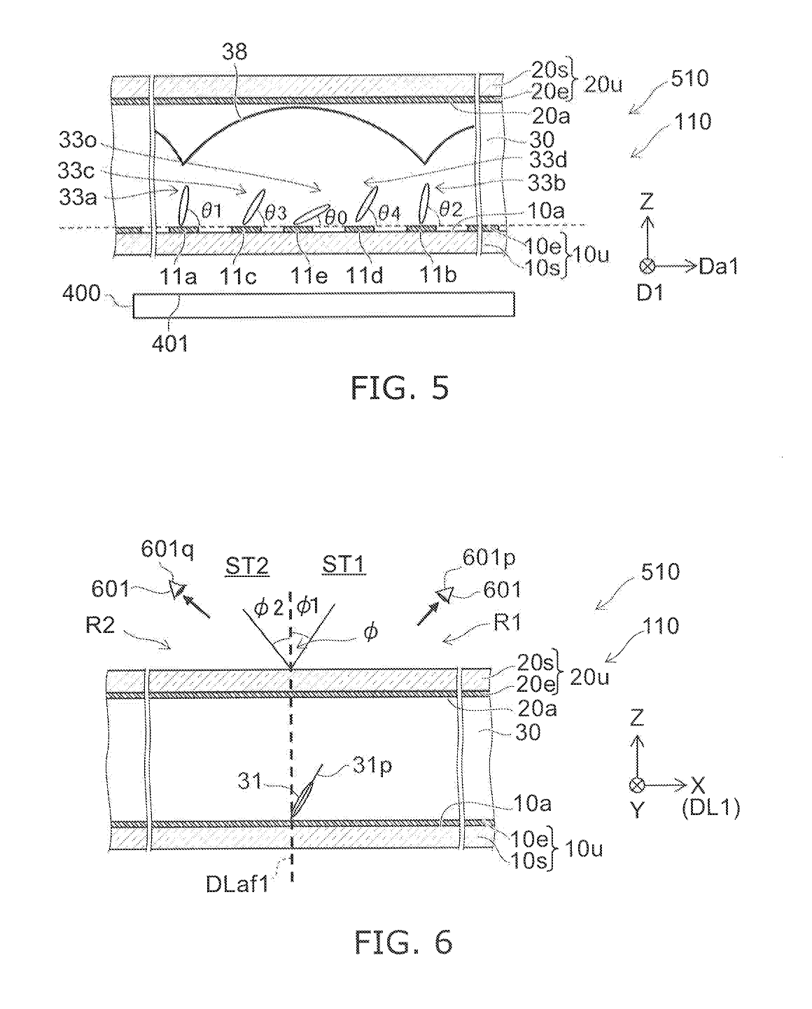

FIG. 5 is a schematic cross-sectional view illustrating the image display apparatus according to the first embodiment.

FIG. 5 illustrates a characteristic of the liquid crystal lens device 110 and the image display apparatus 510.

As shown in FIG. 5, the liquid crystal layer 30 includes first to fourth portions 33a to 33d. The first portion 33a is positioned between the first conductive portion 11a and the second electrode 20e. The second portion 33b is positioned between the second conductive portion 11b and the second electrode 20e. The third portion 33c is positioned between the third conductive portion 11c and the second electrode 20e. The fourth portion 33d is positioned between the fourth conductive portion 11d and the second electrode 20e.

In the example, the liquid crystal layer 30 further includes a central portion 33o. The central portion 33o is positioned between the second electrode 20e and the portion between the third conductive portion 11c and the fourth conductive portion 11d. In the example, the fifth conductive portion 11e is provided between the third conductive portion 11c and the fourth conductive portion 11d. The central portion 33o is, for example, the portion positioned between the fifth conductive portion 11e and the second electrode 20e.

The alignment of the liquid crystal layer 30 is controlled and the refractive index distribution is formed inside the liquid crystal layer 30 by the voltage between the first electrode 10e and the second electrode 20e being controlled by the first driver 150. To simplify the description hereinbelow, the potential of the second electrode 20e is taken to be fixed. For example, the potential of the second electrode 20e is set to be the ground potential.

On the other hand, mutually-different voltages are applied to the multiple conductive portions 11. For example, a high voltage (a first voltage) is applied between the first conductive portion 11a and the second electrode 20e. The high voltage also is applied between the second conductive portion 11b and the second electrode 20e. A low voltage (a second voltage) is applied between the third conductive portion 11c and the second electrode 20e. The low voltage (the second voltage) also is applied between the fourth conductive portion 11d and the second electrode 20e. The second voltage is lower than the first voltage. The potential of the fifth conductive portion 11e is set to be, for example, the same as the potential of the second electrode 20e. The alignment of the liquid crystal layer 30 is determined by the elastic energy and the inductive energy due to the voltage applied to the liquid crystal layer 30.

For example, the tilt angle (the angle between the first surface 10a and the long-axis direction 31p of the liquid crystal angle at the second portion 33b is a second angle θ2. The tilt angle at the third portion 33c is a third angle θ3. The third angle θ3 is smaller than the first angle θ1 and smaller than the second angle θ2. The tilt angle at the fourth portion 33d is a fourth angle θ4. The fourth angle θ4 is smaller than the first angle θ1 and smaller than the second angle θ2. The tilt angle at the central portion 33o is a center angle θ0. The center angle θ0 is smaller than the third angle θ3 and smaller than the fourth angle θ4. The center angle θ0 is, for example, the initial pretilt angle.

In other words, in the first state ST1, the tilt angle (the angle between the first surface 10a and the long-axis direction 31p of the liquid crystal molecules 31) at the central portion 33o (the portion between the second electrode 20e and the portion between the third conductive portion 11c and the fourth conductive portion 11d) inside the liquid crystal layer 30 is smaller than the third angle θ3 and smaller than the fourth angle θ4.

Although the first alignment direction DL1 is relatively aligned with the first direction D1 in the embodiment, the long-axis direction 31p of the liquid crystal molecules 31 is shown as being in a plane defined by the Z-axis direction and a direction Da1 for easier viewing in FIG. 5.

Thus, the tilt angle of the liquid crystal is large at the first portion 33a and the second portion 33b. The tilt angle of the liquid crystal is small at the central portion 33o. The tilt angle of the liquid crystal at the third portion 33c and the fourth portion 33d is smaller than the tilt angle at the first portion 33a and the second portion 33b and larger than the tilt angle at the central portion 33o.

Thereby, a refractive index distribution (a refractive index distribution 38) is formed in the liquid crystal layer 30. In other words, a lens is formed. In the refractive index distribution 38, the refractive index changes along the direction Da1 perpendicular to the first direction D1. Then, for the first direction D1, the refractive index is substantially constant. For example, a lens having a lenticular configuration is formed. A lens that extends in the first direction D1 may be multiply formed.

In the refractive index distribution 38 illustrated in FIG. 5, the vertical direction of the drawing corresponds to the effective refractive index; and the horizontal direction of the drawing corresponds to the direction Da1 perpendicular to the first direction D1. The refractive index distribution 38 is a refractive index for the light (the light parallel to the Z-axis direction) incident on the liquid crystal lens device 110 from the front.

The first portion 33a and the second portion 33b correspond to the lens edges; and the central portion 330 corresponds to the lens center. The third portion 33c and the fourth portion 33d correspond to the lens tilted portions between the lens edges and the lens center.

Thus, the refractive index distribution 38 (the lens) is formed along the direction Da1 perpendicular to the first direction D1 and perpendicular to the Z-axis direction. The liquid crystal lens device 110 functions as, for example, a liquid crystal GRIN lens (Gradient Index lens). FIG. 3 illustrates one liquid crystal GRIN lens. Such a lens is multiply formed along the direction Da1.

In such a case, the display 400 includes, for example, multiple pixel groups (e.g., first to fifth pixels, etc.). The multiple pixel groups are aligned, for example, in a matrix configuration in a plane (e.g., the X-Y plane) parallel to the display surface 401. Multiple parallax images are displayed by the multiple pixel groups. The multiple parallax images are, for example, images corresponding to the parallax of the viewer. The light (the image light 400L) that includes the multiple parallax images is incident on the liquid crystal lens device 110. The three-dimensional image is perceived by viewing the image light 400L including the multiple parallax images via the refractive index distribution 38 (the lens) formed in the liquid crystal lens device 110. On the other hand, in the case where a voltage is not applied to the liquid crystal layer 30, the refractive index of the liquid crystal layer 30 is constant. In such a case, the display image of the display 400 is an image that does not include parallax. Thereby, a high definition two-dimensional image is provided.

The inventor of the application discovered that the display quality decreases according to the relationship between the position of the eye 601 of the user 600 and the direction of the pretilt.

FIG. 6 is a schematic cross-sectional view illustrating the liquid crystal lens device according to the first embodiment.

In the liquid crystal layer 30 as shown in FIG. 6, the long-axis direction 31p of the liquid crystal molecules 31 is tilted with respect to the first surface 10a. When the voltage is applied to the liquid crystal layer 30, the tilt direction of the long-axis direction 31p of the liquid crystal molecules 31 becomes a direction corresponding to the initial alignment (the pretilt). When the voltage applied to the liquid crystal layer 30 is the high voltage, the viewing angle dependence of the effective refractive index of the liquid crystal layer 30 is low because the long-axis direction 31p is substantially perpendicular to the first surface 10a. Conversely, when the voltage applied to the liquid crystal layer 30 is a medium level, the long-axis direction 31p of the liquid crystal molecules 31 tilts at a large angle with respect to the first surface 10a. Therefore, the viewing angle dependence of the effective refractive index of the liquid crystal layer 30 is high. In other words, the viewing angle dependence of the effective refractive index is high at the lens tilted portions of the third portion 33c and the fourth portion 33d when the applied voltage is the medium level.

For example, when the viewpoint is positioned inside the first region R1, the effective refractive index of the liquid crystal layer 30 is less than the effective refractive index of the liquid crystal layer 30 when the viewpoint is positioned inside the second region R2. This is due to the birefringence of the liquid crystal.

For example, the angle between the Z-axis direction and the position of the viewpoint (the position of the eye 601) is referred to as a viewing angle φ). The viewing angle (a first viewing angle φ1) is positive when the viewpoint is positioned inside the first region R1. The viewing angle (a second viewing angle φ2) is negative when the viewpoint is positioned inside the second region R2. The state in which the viewing angle φ is positive corresponds to the state in which the line segment that connects the liquid crystal layer 30 and the viewpoint is relatively aligned with the long-axis direction of the liquid crystal molecules 31. The state in which the viewing angle φ is negative corresponds to the state in which the line segment that connects the liquid crystal layer 30 and the viewpoint is relatively aligned with the short-axis direction of the liquid crystal molecules 31.

The desired optical characteristics are not obtained when the effective refractive index of the liquid crystal layer 30 is different between the case where the viewpoint is at the first position 601p inside the first region R1 and the case where the viewpoint is at the second position 601q inside the second region R2. Therefore, for example, the appropriate lens effect is not obtained; and the appropriate three-dimensional image is not obtained.

The embodiment solves this newly-discovered problem.

In the embodiment, the first driver 150 is capable of implementing a first operation recited below in the first state ST1 in which the estimated position of the eye 601 is the first position 601p. Also, the first driver 150 is capable of implementing a second operation recited below in the second state ST2 in which the estimated position of the eye 601 is the second position 601q. The alignment state of the liquid crystal at the lens tilted portions of the third portion 33c and the fourth portion 33d where the applied voltage is the medium level is different between the first operation and the second operation.

For example, the applied voltage at the third portion 33c in the second operation is modified from the applied voltage at the third portion 33c in the first operation. For example, the applied voltage at the fourth portion 33d in the second operation is modified from the applied voltage at the fourth portion 33d in the first operation. For example, the applied voltage at the third portion 33c in the first operation is modified from the applied voltage at the third portion 33c in the second operation. For example, the applied voltage at the fourth portion 33d in the first operation is modified from the applied voltage at the fourth portion 33d in the second operation.

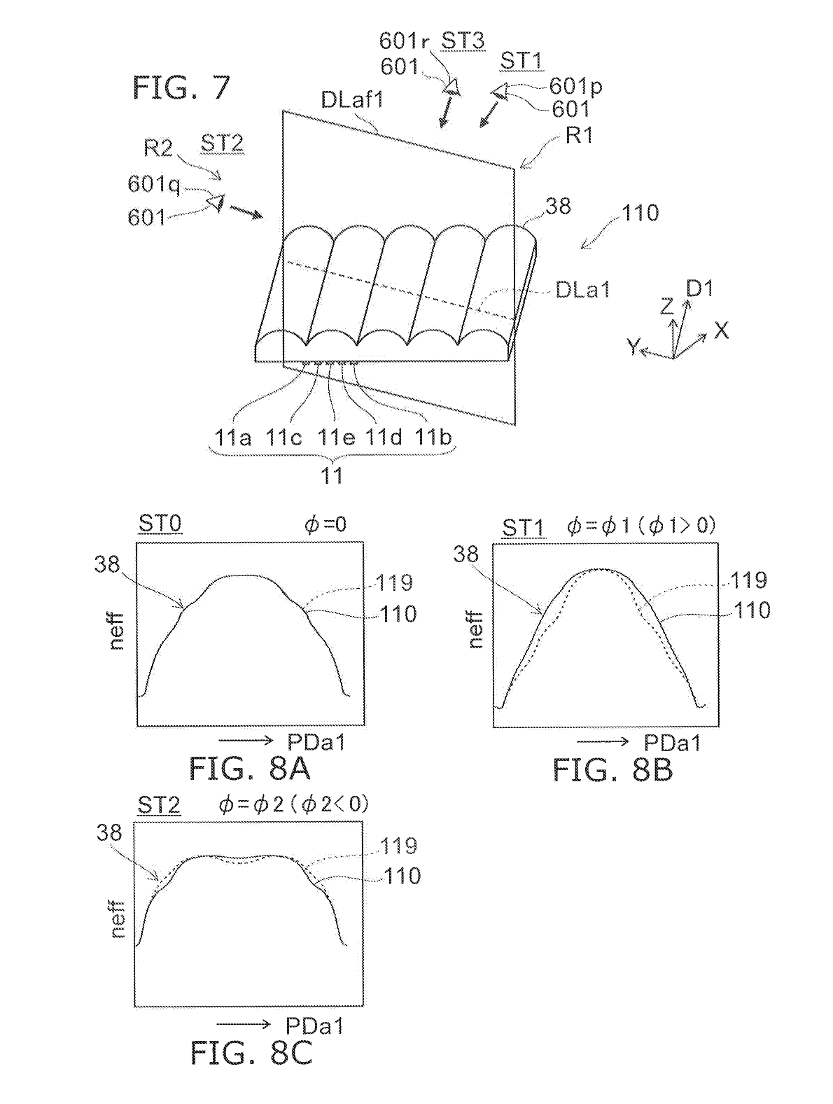

FIG. 7 is a schematic perspective view illustrating operations of the liquid crystal lens device according to the first embodiment.

In FIG. 7, the refractive index distribution 38 of the liquid crystal lens device 110 is illustrated as a lens having a lenticular configuration. The lens extends along the first direction D1 (the extension direction of the multiple conductive portions 11). In the example, the angle between the line segment DLa1 (the Y-axis direction) and the first direction D1 is not less than 45 degrees. The first region R1 is partitioned from the second region R2 by the first short axis plane DLaf1.

In the embodiment, the tilt angles at the lens tilted portions (the third portion 33c and the fourth portion 33d) are modified between the first state ST1 in which the estimated position of the eye 601 is the first position 601p and the second state ST2 in which the estimated position of the eye 601 is the second position 601q.

For example, in the first operation (the first state), the first driver 150 sets the tilt angle (the angle between the first surface and the long-axis direction 31p of the liquid crystal molecules 31) at the first portion 33a to be the first angle θ1, the tilt angle at the second portion 33b to be the second angle θ2, the tilt angle at the third portion 33c to be the third angle θ3, and the tilt angle at the fourth portion 33d to be the fourth angle θ4. The third angle θ3 is smaller than the first angle θ1 and the second angle θ2. The fourth angle θ4 is smaller than the first angle θ1 and the second angle θ2.

Then, in the second state ST2, the first driver 150 sets the tilt angle (the angle between the first surface 10a and the long-axis direction 31p of the liquid crystal molecules 31) at the third portion 33c to be larger than the third angle θ3 recited above (the second operation). In the second state ST2, the tilt angle at the third portion 33c is smaller than the first angle θ1 and smaller than the second angle θ2.

Then, as in the example, when the absolute value of the angle between the first direction D1 and the first alignment direction DL1 (the X-axis direction) is not less than 0 degrees and not more than 45 degrees, the second operation that is implemented by the first driver 150 further includes setting the tilt angle at the fourth portion 33d to be smaller than the fourth angle θ4 recited above in the second state ST2.

In other words, for the tilt angles at the lens tilted portions (the third portion 33c and the fourth portion 33d) of the intermediate voltage, the values in the second state ST2 are set to be larger than the values in the first state ST1. In other words, for the effective refractive indices at the lens tilted portions (the third portion 33c and the fourth portion 33d) of the intermediate voltage, the values in the second state ST2 are set to be lower than the values in the first state ST1. Thereby, the viewing angle dependence of the effective refractive index is compensated; and a liquid crystal lens device having good optical characteristics is obtained. In other words, a liquid crystal lens device having good optical characteristics can be obtained; and an image display apparatus having high display quality can be provided.

Although the case is described in the description recited above where the alignment of the liquid crystal is changed between when the position of the eye 601 is in the first region R1 and when the position is in the second region R2, the alignment of the liquid crystal may be changed between when the position of the eye 601 is at the front of the liquid crystal lens device 110 and when the position is in the first region R1. Also, the alignment of the liquid crystal may be changed between when the position of the eye 601 is at the front of the liquid crystal lens device 110 and when the position is in the second region R2.

For example, in the embodiment, the tilt angles at the lens tilted portions (the third portion 33c and the fourth portion 33d) of the intermediate voltage in a front state in which the user 600 is at the front of the liquid crystal lens device 110 are between the tilt angles in the first state ST1 and the tilt angles in the second state ST2.

For example, in the embodiment, the applied voltage (the absolute value or the effective value of the applied voltage) of the lens tilted portions (the third portion 33c and the fourth portion 33d) of the intermediate voltage in the front state is a value between the applied voltage (the absolute value or the effective value of the applied voltage) in the first state ST1 and the applied voltage (the absolute value or the effective value of the applied voltage) in the second state ST2.

Thereby, the viewing angle dependence of the effective refractive index can be compensated; a liquid crystal lens device having good optical characteristics can be obtained; and an image display apparatus having high display quality can be provided.

FIG. 7 shows a third state ST3 in which the position of the eye 601 is in the first region R1. The third state ST3 is described below.

An example of characteristics of the liquid crystal lens device 110 according to the embodiment will now be described with a reference example. An example in which the tilt angle of the liquid crystal molecules 31 is changed between the front state, the first state ST1, and the second state ST2 will now be described.

FIG. 8A to FIG. 8C are graphs illustrating characteristics of the liquid crystal lens devices.

These graphs show simulation results of the refractive index distribution 38 formed in the liquid crystal lens device. FIG. 8A corresponds to when the viewing angle φ is 0 (a front state ST0) and corresponds to the case where the user 600 views the liquid crystal lens device 110 from the front. FIG. 8B corresponds to when the viewing angle φ is the first viewing angle φ1 and corresponds to the first state ST1. The first viewing angle φ1 is positive. FIG. 8C corresponds to when the viewing angle φ is the second viewing angle φ2 and corresponds to the second state ST2. The second viewing angle φ2 is negative.

In these graphs, the horizontal axis is a position PDa1 in the direction Da1 (the direction perpendicular to the first direction D1 in which the multiple conductive portions 11 extend). The vertical axis is an effective refractive index neff. In these graphs, the characteristic of the liquid crystal lens device 110 according to the embodiment is illustrated by a solid line. The characteristic of a liquid crystal lens device 119 (of which the structure is not shown) of a first reference example is illustrated by a broken line. In the liquid crystal lens device 119 of the first reference example, the alignment of the liquid crystal of the liquid crystal layer 30 is constant without being changed, regardless of the position of the eye 601 of the user 600.

On the other hand, in the liquid crystal lens device 110 according to the embodiment, as recited above, the tilt angles at the third portion 33c and the fourth portion 33d in the second state ST2 are set to be larger than those in the first state ST1. The tilt angle in the front state ST0 is set to be a medium value that is between those of the first state ST1 and the second state ST2. In the case where the liquid crystal layer 30 has a positive dielectric anisotropy, the voltages applied to the fourth portion 33d and the third portion 33c in the second state ST2 are higher than the values in the first state ST1. For example, the voltages applied to the fourth portion 33d and the third portion 33c in the front state ST0 are set to be medium values that are between those of the first state ST1 and the second state ST2.

As shown in FIG. 8A, the appropriate refractive index distribution 38 is formed in both the embodiment and the first reference example when the viewing angle φ is 0 (the front state ST0). In other words, the refractive index distribution 38 having a lens configuration is formed.

On the other hand, for the liquid crystal lens device 119 of the first reference example in the first state ST1 as illustrated by the broken line in FIG. 8B, the effective refractive index neff is low at the lens tilted portions for the refractive index distribution 38. The refractive index distribution 38 of the first reference example is greatly deformed from the refractive index distribution shown in FIG. 8A. This is because the effective refractive index neff decreases because the line (the visual confirmation direction) that connects the first position 601p and the liquid crystal lens device is aligned with the long-axis direction 31p of the liquid crystal molecules 31 at the lens tilted portions of the intermediate voltage in the first state ST1.

On the other hand, for the liquid crystal lens device 119 of the first reference example in the second state ST2 as illustrated by the broken line in FIG. 8C, the effective refractive index neff is high at the lens tilted portions for the refractive index distribution 38. The refractive index distribution 38 of the first reference example is greatly deformed from the refractive index distribution shown in FIG. 8A. This is because the effective refractive index neff is high because the line (the visual confirmation direction) that connects the second position 601q and the liquid crystal lens device is aligned with the short-axis direction of the liquid crystal molecules 31 at the lens tilted portions of the intermediate voltage in the second state ST2.

Thus, in the first reference example in which the tilt angle of the liquid crystal molecules 31 is not changed regardless of the position of the eye 601, the viewing angle dependence of the optical characteristics of the lens is high.

Conversely, for the liquid crystal lens device 110 according to the embodiment in the first state ST1 as illustrated by the solid line in FIG. 8B, the effective refractive index neff at the lens tilted portions for the refractive index distribution 38 is maintained to be high, i.e., about the same as that of the front state ST0. This is because the tilt angle of the liquid crystal molecules 31 at the lens tilted portions in the first state ST1 is set to be lower than the tilt angle in the front state ST0. Thereby, in the first state ST1 as well, the effective refractive index neff of the lens tilted portions can be maintained to be high. Thereby, the desired refractive index distribution 38 is obtained even in the first state ST1.

For the liquid crystal lens device 110 according to the embodiment in the second state ST2 as illustrated by the solid line in FIG. 8C, the effective refractive index neff is lower than that of the liquid crystal lens device 119 at the lens tilted portions for the refractive index distribution 38. The difference of the configuration of the refractive index distribution 38 between the front state ST0 and the second state ST2 is smaller for the liquid crystal lens device 110 than for the liquid crystal lens device 119. This is because the tilt angle of the liquid crystal molecules 31 at the lens tilted portions in the second state ST2 is set to be higher than the tilt angle in the front state ST0. Thereby, in the second state ST2 as well, the effective refractive index neff of the lens tilted portions can be maintained to be low. Thereby, the desired refractive index distribution 38 is obtained even in the second state ST2.

Thus, according to the embodiment, a liquid crystal lens device and an image display device having good optical characteristics can be provided.

Another example of multiple regions will now be described.

FIG. 9 is a schematic cross-sectional view illustrating another image display apparatus according to the first embodiment.

In the image display apparatus 511 as illustrated in FIG. 9, the second substrate unit 20u is disposed between the display 400 and the first substrate unit 10u. Otherwise, the liquid crystal lens device and the image display apparatus are similar to the liquid crystal lens device 110 and the image display apparatus 510, and a description is therefore omitted.

As illustrated in FIG. 9, in such a case as well, the space is partitioned into four spatial regions (the first to fourth spatial regions r1 to r4) by the first short axis plane DLaf1 and the plane 10f. In such a case as well, the second spatial region r2 is arranged with the first spatial region r1 along the first surface 10a. The fourth spatial region r4 is arranged with the third spatial region r3 along the first surface 10a. The fourth spatial region r4 is arranged with the first spatial region r1 along the Z-axis direction. The third spatial region r3 is arranged with the second spatial region r2 along the Z-axis direction. The long-axis central direction DLb1 passes through the first spatial region r1 and the third spatial region r3. The short-axis central direction DLc1 passes through the second spatial region r2 and the fourth spatial region r4.

In the example, the third spatial region r3 corresponds to the first region R1; and the fourth spatial region r4 corresponds to the second region R2.

In the liquid crystal lens device 111, the first substrate unit 10u is disposed between the first region R1 and the second substrate unit 20u and between the second region R2 and the second substrate unit 20u. In such a case as well, the first position 601p of the eye 601 is disposed inside the first region R1; and the second position 601q of the eye 601 is disposed inside the second region R2. The plane that is parallel to the second surface 20a and includes the second surface 20a is referred to as a plane 20f. In the example, the first substrate unit 10u is disposed between the first position 601p and the plane 20f. The first substrate unit 10u is disposed between the second position 601q and the plane 20f.

In the example as well, the tilt angle of the liquid crystal layer 30 is modified according to whether the position of the eye 601 is positioned inside the first region R1 or inside the second region R2. Thereby, a liquid crystal lens device and an image display apparatus having good optical characteristics can be provided.

In the embodiment, for example, the liquid crystal layer 30 has positive dielectric anisotropy. In such a case, the first driver 150 sets the absolute value of the voltage between the third conductive portion 11c and the second electrode 20e in the second operation (the second state ST2) to be greater than the absolute value of the voltage between the third conductive portion 11c and the second electrode 20e in the first operation (the first state ST1). Also, the first driver 150 sets the absolute value of the voltage between the fourth conductive portion 11d and the second electrode 20e in the second operation to be greater than the absolute value of the voltage between the fourth conductive portion 11d and the second electrode 20e in the first operation. In other words, the tilt angles at the lens tilted portions are set to be larger in the second state ST2 than in the first state ST1. Thereby, at the lens tilted portions, the viewing angle dependence of the effective refractive index neff in the second state ST2 and the effective refractive index in the first state ST1 can be compensated.

In the embodiment, for example, the liquid crystal layer 30 has negative dielectric anisotropy. In such a case, the first driver 150 sets the absolute value of the voltage between the third conductive portion 11c and the second electrode 20e in the second operation to be less than the absolute value of the voltage between the third conductive portion 11c and the second electrode 20e in the first operation. Also, the first driver 150 sets the absolute value of the voltage between the fourth conductive portion 11d and the second electrode 20e in the second operation to be less than the absolute value of the voltage between the fourth conductive portion 11d and the second electrode 20e in the first operation. In other words, the tilt angles at the lens tilted portions are set to be larger in the second state ST2 than in the first state ST1. Thereby, at the lens tilted portions, the viewing angle dependence of the effective refractive index neff in the second state ST2 and the effective refractive index in the first state ST1 can be compensated.

In such a case, the tilt angles at the first portion 33a and the second portion 33b which correspond to the lens edges may be constant regardless of the position of the eye 601. In other words, the voltages applied to the lens edges may not be modified. As recited above, good optical characteristics are obtained without modifying the tilt angle (i.e., the applied voltage) at the lens edges because the viewing angle dependence of the effective refractive index at the lens edges is small.

For example, in the second state ST2 in the second operation, the first driver 150 may set the tilt angle (the angle between the first surface 10a and the long-axis direction 31p of the liquid crystal molecules 31) at the third portion 33c to be the same as the third angle θ3, and may set the tilt angle at the fourth portion 33d to be the same as the fourth angle θ4. In other words, in the second operation, the first driver 150 may set the voltage between the third conductive portion 11c and the second electrode 20e in the second state ST2 to be the same as the voltage between the third conductive portion 11c and the second electrode 20e in the first state ST1, and may set the voltage between the fourth conductive portion 11d and the second electrode 20e in the second state ST2 to be the same as the voltage between the fourth conductive portion 11d and the second electrode 20e in the first state ST1.

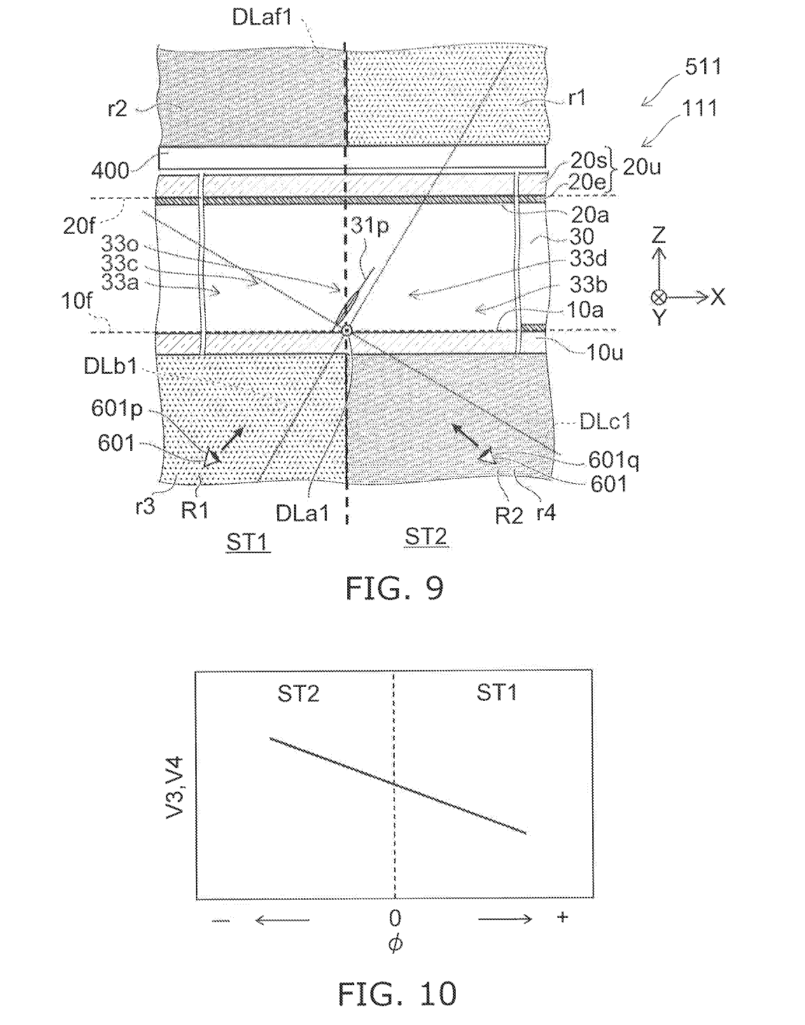

FIG. 10 is a graph illustrating another liquid crystal lens device and according to the first embodiment.

FIG. 10 illustrates the voltage applied to the liquid crystal layer 30 in the case where the dielectric anisotropy of the liquid crystal layer 30 is positive. The horizontal axis is the viewing angle φ. The vertical axis is a third voltage V3 between the third conductive portion 11c and the second electrode 20e and a fourth voltage V4 between the fourth conductive portion 11d and the second electrode 20e. In the example, the fourth voltage V4 is the same as the third voltage V3. These voltages are the applied voltages at the lens tilted portions. A positive viewing angle φ corresponds to the first state ST1. A negative viewing angle φ corresponds to the second state ST2.

As shown in FIG. 10, the applied voltage is changed according to the viewing angle φ. The applied voltage in the second state ST2 is higher than the applied voltage in the first state ST1. In the example, the applied voltage is changed linearly with the viewing angle φ. The change may have a curved configuration.

The tilt angle of the liquid crystal layer 30 may be modified when the position of the eye 601 is at two different positions in the first region R1. In other words, the applied voltage may be modified.

As shown in FIG. 7, for example, in the third state ST3, a third position of the eye 601 estimated by the position estimation unit 160 is taken to be inside the first region R1. Also, the third position is different from the first position 601p. For example, the angle between the third position and the first surface 10a is larger than the angle between the first position 601p and the first surface 10a. In other words, the viewing angle φ in the third state ST3 (the third position) is smaller than the viewing angle φ in the first state ST1 (the first position 601p). The viewing angle φ in the third state ST3 is positive.

In such a case, the tilt angle in the third state ST3 is set to be larger than the tilt angle in the first state ST1. However, the tilt angles in such cases are smaller than the tilt angles at the lens edges. For example, in the third state ST3, the first driver 150 may implement a third operation of setting the tilt angle (the angle between the first surface 10a and the long-axis direction 31p of the liquid crystal molecules 31) at the third portion 33c to be smaller than the first angle θ1 and the second angle θ2 and larger than the third angle θ3. The tilt angle at the third portion 33c in the third state ST3 is smaller than the tilt angle at the third portion 33c in the second state ST2. Thereby, good optical characteristics are provided even when the position of the eye 601 changes inside the first region R1.

Similarly, the tilt angles at the lens tilted portions may be modified when the position of the eye 601 changes inside the second region R2. For example, in a fourth state, a fourth position of the eye 601 estimated by the position estimation unit 160 is taken to be inside the second region R2. Also, the angle between the fourth position and the first surface 10a is larger than the angle between the second position 601q and the first surface 10a. In other words, the absolute value of the viewing angle φ in the fourth state (the fourth position) is less than the absolute value of the viewing angle φ in the second state ST2 (the second position 601q). The viewing angle φ in the fourth state is negative.

In such a case, the tilt angle in the fourth state is set to be smaller than the tilt angle in the second state ST2. The tilt angle in the fourth state is larger than the tilt angle in the first state ST1. For example, in the fourth state, the first driver 150 sets the tilt angle at the third portion 33c larger than the tilt angle in the third portion 33c in the first sate ST1. Thereby, good optical characteristics can be provided even when the position of the eye 601 changes inside the second region R2.

The effect of the compensation of the optical characteristics due to the modification of the tilt angles at the lens tilted portions of the liquid crystal layer 30 is greater when the absolute value of the viewing angle φ is large. For example, the first driver 150 may implement the second operation recited above when the absolute value of the angle between the Z-axis direction (the direction perpendicular to the first surface 10a) and the line segment connecting the second position 601q and the centroid 10ac of the first surface 10a is 20 degrees or more. In other words, the first driver 150 modifies the applied voltage when, for example, the absolute value of the angle recited above is 20 degrees or more.

When the absolute value of the viewing angle φ is small, the operations recited above may not be implemented. For example, when the absolute value of the angle between the Z-axis direction and the line segment connecting the second position 601q and the centroid 10ac is less than 5 degrees, the first driver 150 may set the tilt angle (the angle between the first surface 10a and the long-axis direction 31p of the liquid crystal molecules 31) at the third portion 33c in the second state ST2 to be the same as the third angle θ3 in the first state ST1. In other words, the applied voltage may not be modified when the absolute value of the angle recited above is less than, for example, 5 degrees.

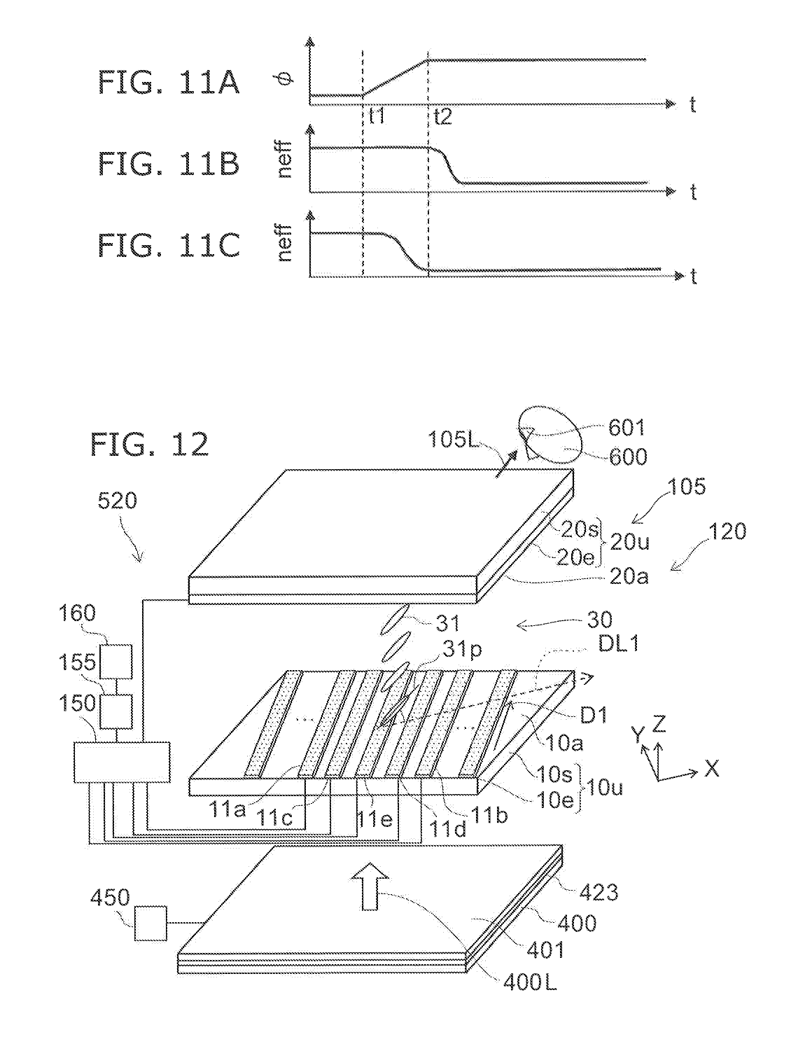

FIG. 11A to FIG. 11C are schematic cross-sectional views illustrating operations of another liquid crystal lens device according to the first embodiment.

In these drawings, the horizontal axis is time t. FIG. 11A shows an example of the change of the viewing angle φ over time t. FIG. 11B shows an example of the change of the effective refractive index neff at the lens tilted portions over time t. FIG. 11C shows another example of the change of the effective refractive index neff at the lens tilted portions over time t. The viewing angle φ is based on the position of the eye 601 of the user 600 sensed by the position estimation unit 160. The effective refractive index neff is based on the voltage applied to the lens unit controlled by the first driver 150.

As shown in FIG. 11A, the viewing angle φ (the position of the eye 601 of the user 600) changes from a first time t1 to a second time t2. In such a case, as shown in FIG. 11B, the temporal change of the effective refractive index neff may be delayed from the temporal change of the viewing angle φ. For example, in the case where the thickness of the liquid crystal layer 30 is thick and the response rate to the voltage applied to the liquid crystal layer 30 is relatively slow, the change of the effective refractive index neff may be delayed from the change of the viewing angle φ. In the case where the display quality of the image display apparatus degrades due to the delay, the effective refractive index neff may be changed sooner by predicting the change of the viewing angle φ when the viewing angle φ starts to change (the first time t1). In such a case, the final voltage may be applied to the liquid crystal layer 30 after the brief application of a voltage that is higher than the final voltage. Thereby, the responsiveness to the temporal change of the viewing angle φ can be improved; and the display quality can be improved further.

Thus, in the embodiment, the position estimation unit 160 may estimate at least one selected from the movement of the eye 601 of the user 600 in a direction from the first position 601p toward the second position 601q and the movement of the eye 601 from the second position 601q toward the first position 601p. Then, the first driver 150 may modify the tilt angle (the angle between the first surface 10a and the long-axis direction 31p of the liquid crystal molecules 31) for at least one selected from the third portion 33c and the fourth portion 33d based on the movement of the eye 601 that is estimated.

In the embodiment, the position estimation unit 160 may estimate the movement speed of the eye 601 from the first position 601p toward the second position 601q and the movement speed of the eye 601 from the second position 601q toward the first position 601p. The first driver 150 may modify the tilt angle for at least one selected from the third portion 33c and the fourth portion 33d based on the movement speed of the eye 601 that is estimated.

Thereby, the responsiveness to the movement of the eye 601 can be improved; and the display quality can be improved further.

### Second Embodiment

FIG. 12 is a schematic view illustrating an image display apparatus according to a second embodiment.

As shown in FIG. 12, the image display apparatus 520 according to the embodiment includes the liquid crystal lens device 120 and the display 400.

The liquid crystal lens device 120 includes the optical unit 105, the driver (the first driver 150), and the position estimation unit 160. In the example, the relationship between the first direction D1 in which the multiple conductive portions 11 extend and the first alignment direction DL1 of the liquid crystal molecules 31 of the liquid crystal layer 30 is different from that of the first embodiment. Otherwise, the configuration may be similar to that of the first embodiment; and a description is therefore omitted.

In the embodiment, the absolute value of the angle between the first direction D1 and the first alignment direction DL1 is greater than 45 degrees. In other words, although the angle between the first direction D1 and the first alignment direction DL1 in the first embodiment is relatively near 0 degrees, the angle between the first direction D1 and the first alignment direction DL1 in the second embodiment is relatively near 90 degrees.

In the embodiment, the angle between the first direction D1 and the first alignment direction DL1 is, for example, greater than 45 degrees but less than 135 degrees. In other words, the absolute value of the angle is greater than 45 degrees and not more than 90 degrees. It is favorable for the absolute value of the angle to be 88 degrees or less. Thereby, the nonuniformity of the liquid crystal alignment due to the lateral electric field can be suppressed; and the desired optical characteristics can be more uniform.

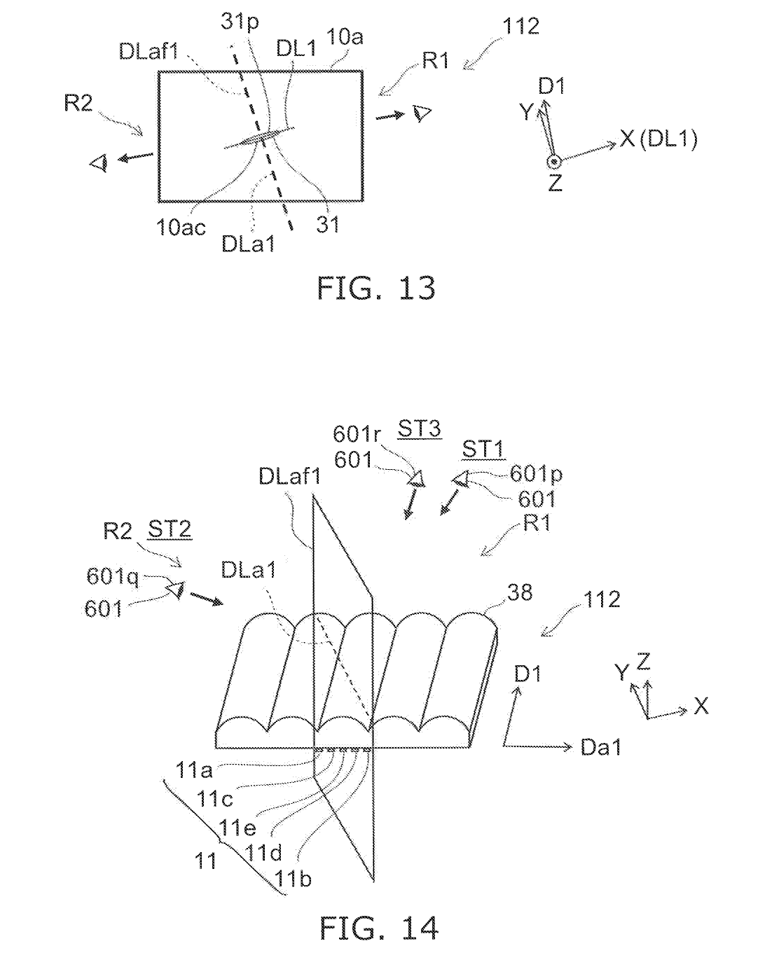

FIG. 13 is a schematic plan view illustrating the liquid crystal lens device according to the second embodiment.

As shown in FIG. 13, in the embodiment as well, the centroid 10ac of the first surface 10a, the first short axis plane DLaf1, the line segment DLa1 (the line segment where the first surface 10a and the first short axis plane DLaf1 intersect), the first region R1, and the second region R2 can be defined.

In the example, the angle between the first alignment direction DL1 (i.e., the X-axis direction) and the first direction D1 is not less than 70 degrees and not more than 85 degrees.

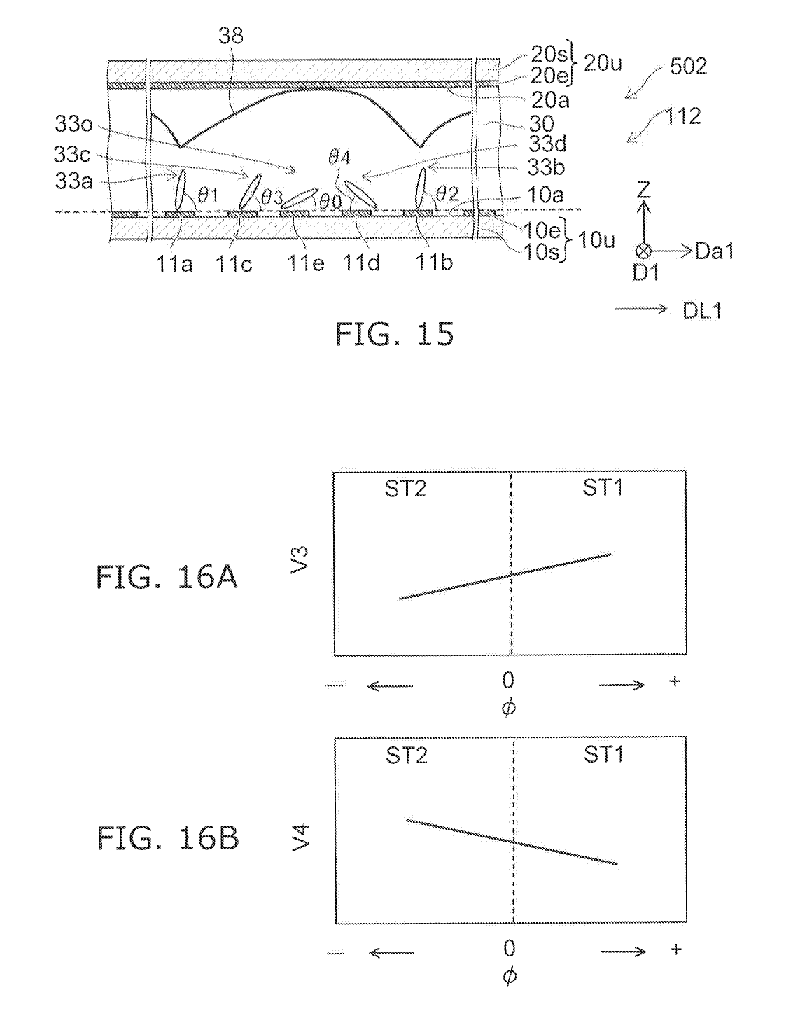

FIG. 14 is a schematic perspective view illustrating the liquid crystal lens device according to the second embodiment.

In such a case as well, the refractive index distribution 38 can be formed by the voltages between the multiple conductive portions 11 and the second electrode 20e (not-shown in FIG. 14). As described above, the first region R1 and the second region R2 are determined based on the first short axis plane DLaf1. In other words, these regions are determined based on the first alignment direction DL1. The relationship between the first region R1 and the second region R2 is a relationship of being rotated around the line segment DLa1. In such a case, the viewing angle φ corresponds to the rotation around the line segment DLa1 (the Y-axis direction). The angle between the line segment DLa1 and the first direction D1 is relatively small. Therefore, the two different positions (the first position 601p and the second position 601q) of the eye 601 are arranged along a direction (i.e., the direction Da1) in which the refractive index of the refractive index distribution 38 changes.

FIG. 15 is a schematic cross-sectional view illustrating the liquid crystal lens device according to the second embodiment.

FIG. 15 illustrates a characteristic of the liquid crystal lens device 110 and the image display apparatus 510. As shown in FIG. 15, the first to fourth portions 33a to 33d and the central portion 33o are provided in the liquid crystal layer 30 to correspond to the first to fifth conductive portions 11a to lie. In the embodiment, the first alignment direction DL1 is relatively aligned with the direction Da1 in which the multiple conductive portions 11 are arranged. Therefore, the tilt direction at each portion of the liquid crystal layer 30 is determined by the effects of the direction of the pretilt and the direction of the electric field.

Here, as illustrated in FIG. 15, the long-axis direction 31p of the liquid crystal molecules 31 in the pretilt is oriented from the first substrate unit 10u toward the second substrate unit 20u when going from the first conductive portion 11a toward the second conductive portion 11b. In other words, when going from the third conductive portion 11c toward the fourth conductive portion 11d, the long-axis direction 31p of the liquid crystal molecules 31 is oriented from the first substrate unit 10u toward the second substrate unit 20u. In the example, the potential between the fifth conductive portion lie and the second electrode 20e is sufficiently small; and the tilt state of the liquid crystal layer 30 at the central portion 33o is the same as the initial tilt state (the pretilt).

When a voltage is applied to the liquid crystal layer 30, the alignment (the tilt direction) at each portion of the liquid crystal layer 30 is determined by the effects of both the direction of such a pretilt and the electric field that occurs. In the example, the tilt direction at the third portion 33c corresponding to the third conductive portion 11c is the same as the tilt direction (the pretilt direction) at the central portion 33o corresponding to the fifth conductive portion lie. On the other hand, the tilt direction at the fourth portion 33d corresponding to the fourth conductive portion 11d is the reverse direction of the pretilt direction. Therefore, the refractive index distribution 38 is asymmetric for the two regions subdivided at the central portion 330.

Thus, in the embodiment, the tilt direction is different at each portion of the liquid crystal layer 30. Both the change of the viewing angle φ and such differences in the tilt direction affect the optical characteristics of the liquid crystal lens device 120.

Such optical characteristics are compensated in the embodiment.

In other words, the voltage that is applied to the third portion 33c and the voltage that is applied to the fourth portion 33d are changed in directions that are the reverse of each other in the two states in which the viewing angle φ is different.

For example, in the first state ST1, the first driver 150 sets the tilt angle at the first portion 33a to be the first angle θ1, the tilt angle at the second portion 33b to be the second angle θ2, the tilt angle at the third portion 33c to be the third angle θ3, and the tilt angle at the fourth portion 33d to be the fourth angle θ4. The third angle θ3 is smaller than the first angle θ1 and smaller than the second angle θ2. The fourth angle θ4 also is smaller than the first angle θ1 and smaller than the second angle θ2. In the example, the fourth angle θ4 may be different from the third angle θ3 due to the effect of the direction of the pretilt.

The first driver 150 is capable of implementing the second operation of setting the tilt angle at the third portion 33c to be larger than the third angle θ3 in the second state ST2. Also, in the second state ST2 in the second operation, the first driver 150 sets the tilt angle at the fourth portion 33d to be smaller than the fourth angle θ4.

Thus, in the embodiment, the direction (the increase or decrease) of the change of the tilt angle is set to be reversed between the third portion 33c and the fourth portion 33d. Thereby, the change of the optical characteristics caused by both the difference of the tilt direction and the change of the viewing angle φ can be compensated. Thereby, a liquid crystal lens device and an image display apparatus having good optical characteristics can be provided.

The change of the tilt angle recited above can be implemented by changing the voltage (the current) supplied from the first driver 150 to the first electrode 10e and the second electrode 20e.

For example, the following is performed in the case where the liquid crystal layer 30 has the positive dielectric anisotropy. The first driver 150 sets the absolute value of the voltage between the third conductive portion 11c and the second electrode 20e in the second operation to be greater than the absolute value of the voltage between the third conductive portion 11c and the second electrode 20e in the first operation. Also, the first driver 150 sets the absolute value of the voltage between the fourth conductive portion 11d and the second electrode 20e in the second operation to be less than the absolute value of the voltage between the fourth conductive portion 11d and the second electrode 20e in the first operation. Thereby, the tilt angle recited above is obtained.

For example, the following is performed in the case where the liquid crystal layer 30 has the negative dielectric anisotropy. The first driver 150 sets the absolute value of the voltage between the third conductive portion 11c and the second electrode 20e in the second operation to be less than the absolute value of the voltage between the third conductive portion 11c and the second electrode 20e in the first operation. Also, the first driver 150 sets the absolute value of the voltage between the fourth conductive portion 11d and the second electrode 20e in the second operation to be greater than the absolute value of the voltage between the fourth conductive portion 11d and the second electrode 20e in the first operation. Thereby, the tilt angle recited above is obtained.

FIG. 16A and FIG. 16B are graphs illustrating another liquid crystal lens device according to the second embodiment.

These graphs illustrate the voltage applied to the liquid crystal layer 30 in the case where the dielectric anisotropy of the liquid crystal layer 30 is positive. The horizontal axis is the viewing angle φ. The vertical axis of FIG. 16A is the third voltage V3 between the third conductive portion 11c and the second electrode 20e. The vertical axis of FIG. 16B is the fourth voltage V4 between the fourth conductive portion 11d and the second electrode 20e. These voltages are the applied voltages at the lens tilted portions. A positive viewing angle φ corresponds to the first state ST1. A negative viewing angle φ corresponds to the second state ST2.

As shown in FIG. 16A and FIG. 16B, the direction of the increase or decrease of the applied voltage as the viewing angle φ changes is reversed between the third voltage V3 and the fourth voltage V4. In the example, the applied voltage is changed linearly with the viewing angle. The change may have a curved configuration.

In the embodiment, the third voltage V3 when the viewing angle φ is 0 may be different from the fourth voltage V4 when the viewing angle φ is 0. Thereby, the asymmetry of the optical characteristics in the frontward direction can be compensated.

In the embodiment as well, the tilt angle of the liquid crystal layer 30 may be modified when the position of the eye 601 is at two different positions in the first region R1. In other words, the applied voltage may be modified.

As shown in FIG. 14, for example, in the third state ST3, the third position of the eye 601 that is estimated by the position estimation unit 160 is taken to be inside the first region R1. For example, the angle between the third position and the first surface 10a is larger than the angle between the first position 601p and the first surface 10a. In other words, the viewing angle φ in the third state ST3 (the third position) is smaller than the viewing angle φ in the first state ST1 (the first position 601p). Therefore, the tilt angle in the third state ST3 is larger than the tilt angle in the first state ST1. However, the tilt angle at this time is smaller than the tilt angle at the lens edges. For example, in the third state ST3, the first driver 150 may implement the third operation of setting the tilt angle (the angle between the first surface 10a and the long-axis direction 31p of the liquid crystal molecules 31) at the third portion 33c to be smaller than the first angle θ1 and the second angle θ2 and larger than the third angle θ3. The tilt angle at the third portion 33c in the third state ST3 is smaller than the tilt angle at the third portion 33c in the second state ST2. Thereby, good optical characteristics can be provided even when the position of the eye 601 changes inside the first region R1.

Similarly, the tilt angles at the lens tilted portions may be modified when the position of the eye 601 changes inside the second region R2.

The effect of the compensation of the optical characteristics due to the modification of the tilt angles at the lens tilted portions of the liquid crystal layer 30 is greater when the absolute value of the viewing angle φ is large. For example, the first driver 150 may implement the second operation recited above when the absolute value of the angle between the Z-axis direction (the direction perpendicular to the first surface 10a) and the line segment connecting the second position 601q and the centroid 10ac of the first surface 10a is 20 degrees or more. In other words, the applied voltage is modified.

The operations recited above may not be implemented when the absolute value of the viewing angle φ is small. For example, the first driver 150 sets the tilt angle (the angle between the first surface 10a and the long-axis direction 31p of the liquid crystal molecules 31) at the third portion 33c in the second state ST2 to be the same as the third angle θ3 in the first state ST1 when the absolute value of the angle between the Z-axis direction and the line segment connecting the second position 601q and the centroid 10ac is less than 5 degrees. In other words, the applied voltage may not be modified.

### Third Embodiment

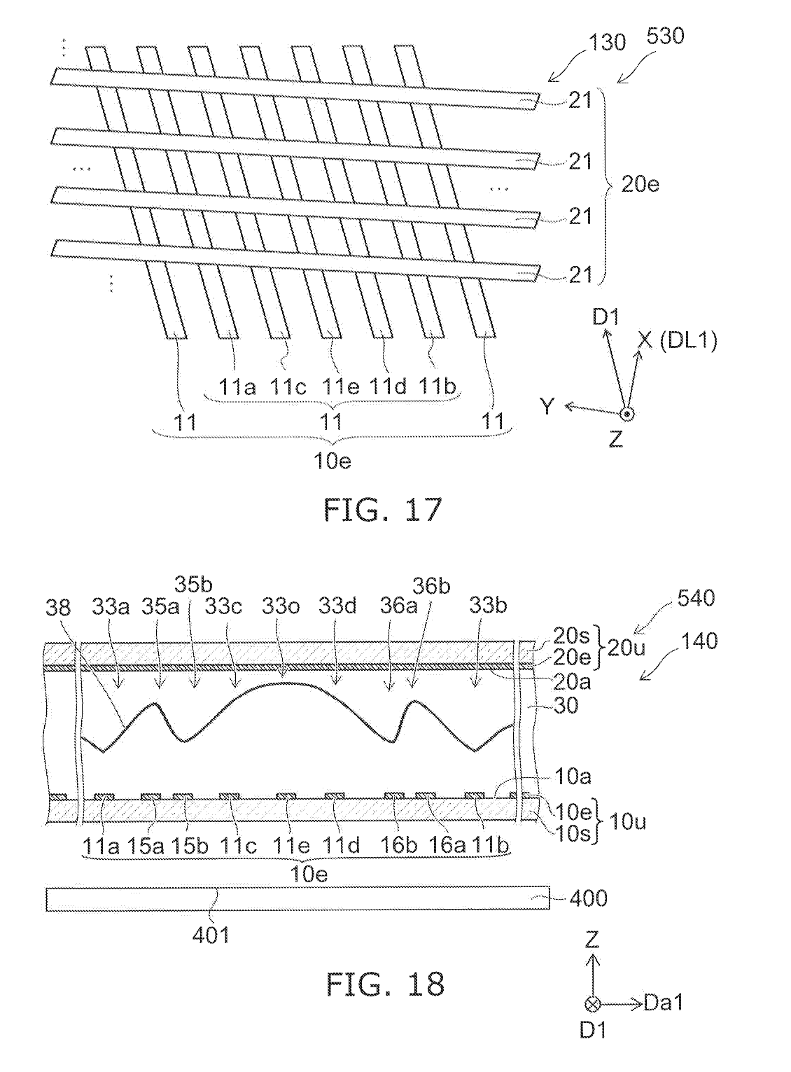

FIG. 17 is a schematic plan view illustrating a liquid crystal lens device according to a third embodiment.

In the liquid crystal lens device 130 and the image display apparatus 530 according to the embodiment as shown in FIG. 17, multiple conductive portions 21 are provided in the second electrode 20e. Each of the multiple conductive portions 21 extends in a direction intersecting the extension direction of the multiple conductive portions 11 of the first electrode 10e. The potentials of the second electrode 20e may be the same or may be different from each other.

In the liquid crystal lens device 130, the refractive index can be changed along a direction perpendicular to the direction in which the second electrode 20e extends by changing the potentials of the multiple conductive portions 21 of the second electrode 20e. Thereby, a refractive index distribution can be formed in a direction different from that of the refractive index distribution 38 formed by the first electrode 10e. The direction of the refractive index distribution can be changed according to the change of the visual confirmation direction of the user 600 for better ease of use.

The configuration of the third embodiment may be combined with the first embodiment and may be combined with the second embodiment.

### Fourth Embodiment

FIG. 18 is a schematic plan view illustrating an image display apparatus according to a fourth embodiment.

In the liquid crystal lens device 140 and the image display apparatus 540 according to the embodiment as shown in FIG. 18, the refractive index distribution 38 is formed in a Fresnel lens-like configuration.

In other words, the first electrode 10e further includes a first middle conductive portion 15a, a second middle conductive portion 15b, a third middle conductive portion 16a, and a fourth middle conductive portion 16b. Each of these middle conductive portions extends in the first direction D1.

The first middle conductive portion 15a is provided between the first conductive portion 11a and the third conductive portion 11c. The second middle conductive portion 15b is provided between the first middle conductive portion 15a and the third conductive portion 11c. The third middle conductive portion 16a is provided between the second conductive portion 11b and the fourth conductive portion 11d. The fourth middle conductive portion 16b is provided between the third middle conductive portion 16a and the fourth conductive portion 11d.

The liquid crystal layer 30 further includes a first middle portion 35a, a second middle portion 35b, a third middle portion 36a, and a fourth middle portion 36b.

The first middle portion 35a is provided between the first middle conductive portion 15a and the second electrode 20e. The second middle portion 35b is provided between the second middle conductive portion 15b and the second electrode 20e. The third middle portion 36a is provided between the third middle conductive portion 16a and the second electrode 20e. The fourth middle portion 36b is provided between the fourth middle conductive portion 16b and the second electrode 20e.

The refractive index distribution 38 illustrated in FIG. 18 can be formed by controlling the voltages between the second electrode 20e and these middle conductive portions.

For example, in the first operation, the first driver 150 sets the tilt angle (the angle between the first surface 10a and the long-axis direction 31p of the liquid crystal molecules 31) at the first middle portion 35a to be smaller than the first angle θ1 and smaller than the second angle θ2. Thereby, the effective refractive index at the first middle portion 35a is higher than the effective refractive index at the first portion 33a and the second portion 33b. Further, in the first operation, the first driver 150 sets the tilt angle (the angle between the first surface 10a and the long-axis direction 31p of the liquid crystal molecules 31) at the second middle portion 35b to be larger than the tilt angle at the first middle portion 35a recited above. Thereby, the effective refractive index at the second middle portion 35b is lower than the effective refractive index at the first middle portion 35a.

Similarly, in the first operation, the first driver 150 sets the tilt angle (the angle between the first surface 10a and the long-axis direction 31p of the liquid crystal molecules 31) at the third middle portion 36a to be smaller than the first angle θ1 and smaller than the second angle θ2. Thereby, the effective refractive index at the third middle portion 36a is higher than the effective refractive index at the first portion 33a and the second portion 33b. Further, in the first operation, the first driver 150 sets the tilt angle (the angle between the first surface 10a and the long-axis direction 31p of the liquid crystal molecules 31) at the fourth middle portion 36b to be larger than the tilt angle at the third middle portion 36a recited above. Thereby, the effective refractive index at the fourth middle portion 36b is lower than the effective refractive index at the third middle portion 36a.

Thereby, the refractive index distribution 38 having the Fresnel lens-like configuration illustrated in FIG. 18 can be formed.

In the example, four lens tilted portions are provided. Namely, the third portion 33c, the fourth portion 33d, the first middle portion 35a, and the third middle portion 36a correspond to the lens tilted portions. In the embodiment, the tilt angles at these lens tilted portions are controlled as described in the first embodiment or the second embodiment.

For example, the first driver 150 is capable of implementing the second operation of setting the tilt angle (the angle between the first surface 10a and the long-axis direction 31p of the liquid crystal molecules 31) at the first middle portion 35a in the second state ST2 to be larger than the tilt angle in the first state ST1.

At this time, for example, as in the first embodiment, the second operation sets the tilt angle at the third middle portion 36a in the second state ST2 to be larger than the tilt angle at the third middle portion 36a in the first state ST1 when the absolute value of the angle between the first direction D1 and the first alignment direction DL1 is not less than 0 degrees and not more than 45 degrees.

On the other hand, for example, as in the second embodiment, the second operation sets the tilt angle at the third middle portion 36a in the second state ST2 to be smaller than the tilt angle at the third middle portion 36a in the first state ST1 when the absolute value of the angle between the first direction D1 and the first alignment direction DL1 is greater than 45 degrees.

Thereby, good optical characteristics can be maintained regardless of the position of the eye 601 of the user 600. In the embodiment as well, a liquid crystal lens device and an image display apparatus having good optical characteristics can be provided.

The operations described in the first embodiment and the second embodiment are applicable to the operations of the embodiment relating to the third portion 33c and the fourth portion 33d of the liquid crystal layer 30.

When applying the voltages between the first electrode 10e and the second electrode 20e in the first to fourth embodiments recited above, it is favorable for the application of the lower voltages to be started after starting the application of the high voltages. Thereby, the nonuniformity of the alignment occurring due to the voltage (e.g., reverse tilt domain, reverse twist domain, etc.) can be suppressed.

In other words, for example, when implementing the first operation, the first driver 150 starts the application of the voltage between the third conductive portion 11c and the second electrode 20e and the application of the voltage between the fourth conductive portion 11d and the second electrode 20e after starting the application of the voltage between the first conductive portion 11a and the second electrode 20e and the application of the voltage between the second conductive portion 11b and the second electrode 20e. Thereby, more uniform optical characteristics are obtained more easily.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, embodiments of the invention are described with reference to specific examples. However, the invention is not limited to these specific examples. For example, one skilled in the art may similarly practice the invention by appropriately selecting specific configurations of components included in the liquid crystal lens device such as the substrate unit, the substrate, the electrode, the conductive portion, the liquid crystal layer, the liquid crystal molecules, the first driver, and the position estimation unit, specific configurations of components included in the image display apparatus such as the display, the display layer, the second driver, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all liquid crystal display devices and image display apparatuses practicable by an appropriate design modification by one skilled in the art based on the liquid crystal display devices and the image display apparatuses described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A liquid crystal lens device, comprising:
an optical unit including
a first substrate having a first surface,
first electrodes provided on the first surface, each first electrode extending in a first direction,
a second substrate having a second surface opposing the first surface, and
a second electrode provided on the second surface, and
a liquid crystal layer provided between the first electrodes and the second electrode and including a liquid crystal molecule, a long-axis direction of the liquid crystal molecule being tilted at a pretilt angle to the first surface in a state without voltage application to the liquid crystal layer, the long-axis direction forming an alignment direction when projected onto the first surface;
an estimator that estimates an estimated position of a user relative to the optical unit; and
a driver that is electrically connected to the first electrodes and the second electrode and performs a first operation to selectively apply a first voltage to the liquid crystal layer in a first mode and a second voltage to the liquid crystal layer in a second mode according to the estimated position,
the estimated position in the first mode being a first position, and the estimated position in the second mode being a second position, a position of the second position in the alignment direction being different from a position of the first position in the alignment direction,
an angle between the long-axis direction and a first straight line connecting the first position and a centroid of the first surface being smaller than an angle between the long-axis direction and a second straight line connecting the second position and the centroid,
a first angle between the first surface and the long-axis direction in the first mode being smaller than a second angle between the first surface and the long-axis direction in the second mode.

2. The device according to claim 1, wherein a plane passing the centroid and being perpendicular to the alignment direction is located between the first position and the second position.

3. The device according to claim 1, wherein
the liquid crystal layer has positive dielectric anisotropy,
the driver sets an absolute value of the first voltage to be greater than an absolute value of the second voltage.

4. The device according to claim 1, wherein
the first electrode includes a first conductive portion, a second conductive portion, a third conductive portion provided between the first conductive portion and the second conductive portion, and a fourth conductive portion provided between the third conductive portion and the second conductive portion,
the liquid crystal layer includes a first portion between the first conductive portion and the second electrode, a second portion between the second conductive portion and the second electrode, a third portion between the third conductive portion and the second electrode, and a fourth portion between the fourth conductive portion and the second electrode,
an absolute value of an angle between the first direction and the first alignment direction is not less than 0 degrees and not more than 45 degrees, and
an angle between the first surface and the long-axis direction in the third portion in the first mode is smaller than an angle between the first surface and the long-axis direction in the third portion in the second mode,
an angle between the first surface and the long-axis direction in the fourth portion in the first mode is smaller than an angle between the first surface and the long-axis direction in the fourth portion in the second mode.

5. The device according to claim 1, wherein
the first electrode includes a first conductive portion, a second conductive portion, a third conductive portion provided between the first conductive portion and the second conductive portion, and a fourth conductive portion provided between the third conductive portion and the second conductive portion,
the liquid crystal layer includes a first portion between the first conductive portion and the second electrode, a second portion between the second conductive portion and the second electrode, a third portion between the third conductive portion and the second electrode, and a fourth portion between the fourth conductive portion and the second electrode,
an absolute value of an angle between the first direction and the first alignment direction is greater than 45 degrees,
the long-axis direction in the pretilt is oriented from the first substrate toward the second substrate when going from the first conductive portion toward the second conductive portion, and
an angle between the first surface and the long-axis direction in the third portion in the first mode is smaller than an angle between the first surface and the long-axis direction in the third portion in the second mode,
an angle between the first surface and the long-axis direction in the fourth portion in the first mode is larger than an angle between the first surface and the long-axis direction in the third portion in the second mode.

6. The device according to claim 5, wherein
the liquid crystal layer has positive dielectric anisotropy,
an absolute value of a voltage between the third conductive portion and the second electrode in the second mode is greater than an absolute value of a voltage between the third conductive portion and the second electrode in the first mode, and
an absolute value of a voltage between the fourth conductive portion and the second electrode in the second mode is less than an absolute value of a voltage between the fourth conductive portion and the second electrode in the first mode.

7. The device according to claim 1, wherein
the first electrode includes a first conductive portion, a second conductive portion, a third conductive portion provided between the first conductive portion and the second conductive portion, and a fourth conductive portion provided between the third conductive portion and the second conductive portion,
the liquid crystal layer includes a first portion between the first conductive portion and the second electrode, a second portion between the second conductive portion and the second electrode, a third portion between the third conductive portion and the second electrode, and a fourth portion between the fourth conductive portion and the second electrode,
an angle between the long-axis direction and a first straight line connecting the first position and a centroid of the first surface being smaller than an angle between the long-axis direction and a second straight line connecting the second position and the centroid,
an angle between the first surface and the long-axis direction at the third portion in the second mode is same as an angle between the first surface and the long-axis direction at the fourth portion at the second.

8. The device according to claim 1, wherein
the driver further selectively applies a third voltage to the liquid crystal layer in a third mode according to the estimated position,
the estimated position in the third mode is a third position, a position of the third position in the alignment direction is located between the position of the first position in the alignment direction and the position of the second position in the alignment direction,
an angle between the long-axis direction and a third straight line connecting the third position and the centroid is larger than the angle between the long-axis direction and the first straight line,
a plane passing the centroid and being perpendicular to the alignment direction is located between the third position and the second position,
a third angle between the first surface and the long-axis direction in the third mode is smaller than the first angle.

9. The device according to claim 1, wherein
the estimator estimates at least one selected from a movement of the user in a direction from the first position toward the second position and a movement of the user in a direction from the second position toward the first position, and
the driver modifies the first angle between the first surface and the long-axis direction based on the estimated movement of the user.

10. The device according to claim 1, wherein the driver performs a second operation to set the second angle to be a same as the first angle when an absolute value of an angle between a direction perpendicular to the first surface and the second straight line is less than 5 degrees.

11. The device according to claim 1, wherein
the first electrode includes a first conductive portion, a second conductive portion, a third conductive portion provided between the first conductive portion and the second conductive portion, and a fourth conductive portion provided between the third conductive portion and the second conductive portion,
the driver starts an application of a voltage between the third conductive portion and the second electrode and an application of a voltage between the fourth conductive portion and the second electrode after starting an application of a voltage between the first conductive portion and the second electrode and an application of a voltage between the second conductive portion and the second electrode.

12. The device according to claim 1, wherein
the first electrode includes
a first conductive portion,
a second conductive portion,
a third conductive portion provided between the first conductive portion and the second conductive portion,
a fourth conductive portion provided between the third conductive portion and the second conductive portion,
a first middle conductive portion provided between the first conductive portion and the third conductive portion, and
a second middle conductive portion provided between the first middle conductive portion and the third conductive portion,
the liquid crystal layer includes
a first portion between the first conductive portion and the second electrode,
a second portion between the second conductive portion and the second electrode,
a third portion between the third conductive portion and the second electrode,
a fourth portion between the fourth conductive portion and the second electrode,
a first middle portion between the first middle conductive portion and the second electrode, and
a second middle portion between the second middle conductive portion and the second electrode,
in the first mode, an angle between the first surface and the long-axis direction at the first middle portion is smaller than an angle between the first surface and the long-axis direction at the first portion and smaller than an angle between the first surface and the long-axis direction at the second portion, and
in the first mode, an angle between the first surface and the long-axis direction at the second middle portion is larger than the angle between the first surface and the long-axis direction at the first middle portion.

13. The device according to claim 1, wherein
the first electrode includes a first conductive portion, a second conductive portion, a third conductive portion provided between the first conductive portion and the second conductive portion, and a fourth conductive portion provided between the third conductive portion and the second conductive portion,
the liquid crystal layer includes a first portion between the first conductive portion and the second electrode, a second portion between the second conductive portion and the second electrode, a third portion between the third conductive portion and the second electrode, a fourth portion between the fourth conductive portion and the second electrode, and a central portion between the second electrode and a portion between the third conductive portion and the fourth conductive portion,
an angle between the first surface and the long-axis direction at the central portion in the first mode is smaller than an angle between the first surface and the long-axis direction at the third portion in the first mode and smaller than an angle between the first surface and the long-axis direction at the fourth portion in the first mode, and
an angle between the first surface and the long-axis direction at the central portion in the second mode is smaller than an angle between the first surface and the long-axis direction at the third portion in the second mode and smaller than an angle between the first surface and the long-axis direction at the fourth portion in the second mode.

14. The device according to claim 1, wherein
the estimator estimates speed at which the user moves from the first position toward the second position and a movement speed of the user in a direction from the second position toward the first position, and
the driver modifies the first angle between the first surface and the long-axis direction based on the estimated movement speed of the user.

15. The device according to claim 1, wherein
the second substrate is disposed between the first position and the first substrate, and
the second substrate is disposed between the second position and the first substrate.

16. The device according to claim 1, wherein
the first substrate is disposed between the first position and the second substrate, and
the first substrate is disposed between the second position and the second substrate.

17. The device according to claim 1, wherein
the liquid crystal layer has a negative dielectric anisotropy,
the driver sets an absolute value of a voltage between the third conductive portion and the second electrode in the second operation to be less than an absolute value of the voltage between the third conductive portion and the second electrode in the first operation, and
the driver sets an absolute value of a voltage between the fourth conductive portion and the second electrode in the second operation to be less than an absolute value of the voltage between the fourth conductive portion and the second electrode in the first operation.

18. The device according to claim 1, wherein
the liquid crystal layer has a negative dielectric anisotropy,
the driver sets an absolute value of the first voltage to be less than an absolute value of the second voltage.

19. The device according to claim 1, wherein the estimator includes a gyroscope that detects an orientation: and
wherein the estimator estimates the position of the user by using the detected orientation.

20. An image display apparatus, comprising:
the device according to claims 1; and
an display stacked with the optical unit.
